(19) United States
(12) Patent Application Publication
(10) Pub. No.: US 2026/0322576 A1
(43) Pub. Date: Oct. 15, 2026

(54) METHOD FOR INTERFERENCE AVOIDING BASED ON TIME DIVISION DUPLEX (TDD) MULTI-PATTERN FRAME STRUCTURE AND DEVICE

(71) Applicant: China Satellite Network Innovation Co., Ltd., Beijing (CN)

(72) Inventors: Lu ZHANG, Beijing (CN); Xue WANG, Beijing (CN); Gaojian WANG, Beijing (CN); Dongqing QI, Beijing (CN); Dongjun MA, Beijing (CN); Ge MANG, Beijing (CN); Niwei WANG, Beijing (CN); Yang ZHANG, Beijing (CN)

(21) Appl. No.: 19/539,621

(22) Filed: Feb. 13, 2026

Related U.S. Application Data
(63) Continuation of application No. PCT/CN2025/113889, filed on Aug. 11, 2025.

(30) Foreign Application Priority Data
Apr. 15, 2025 (CN) 202510469337.5

(51) Int. Cl. H04L 5/14

(52) U.S. Cl. CPC H04L 5/14

(57) ABSTRACT

A method for interference avoiding based on a time division duplex (TDD) multi-pattern frame structure includes: sending a first common signaling based on a first TDD frame structure and sending a second common signaling based on a second TDD frame structure; and receiving a first uplink (UL) signal sent by a terminal using the first TDD frame structure and receiving a second UL signal sent by the terminal using the second TDD frame structure. The first common signaling and the second UL signal are communicated via different frequency domain resources, and the second common signaling and the first UL signal are communicated via different frequency domain resources; and the second TDD frame structure and the first TDD frame structure have a same frame period and a same UL-downlink (DL) slot configuration, and the second TDD frame structure has a fixed frame header offset relative to the first TDD frame structure.

### CROSS-REFERENCE TO RELATED APPLICATIONS

The application is a continuation of International Application No. PCT/CN2025/113889, filed on Aug.11, 2025, which claims priority to Chinese Patent Application No. 202510469337.5, filed on Apr. 15, 2025, named “Method for interference avoiding Based on Time Division Duplex (TDD) Multi-Pattern Frame Structure” by CHINA SATELLITE NETWORK INNOVATION CO., LTD, the entire contents of which are incorporated herein by reference.

### TECHNICAL FIELD

The present disclosure relates to a field of communication technology, and in particular relates to a method for interference avoiding based on a time division duplex (TDD) multi-pattern frame structure and a device.

### BACKGROUND

With increasing importance of a low earth orbit (LEO) satellite system in a global communication network, a design of a satellite-ground user link often adopts a frequency division duplex (FDD) mode. However, in view of shortcomings of the FDD mode such as relatively scarce available spectrum resources, a low spectrum utilization when implementing asymmetric uplink (UL) and downlink (DL) services, and inability of a radio frequency unit to share transmission and reception, the industry has gradually begun to pay attention to application of a time division duplex (TDD) mode.

### SUMMARY

A first aspect of the present disclosure provides a method for interference avoiding based on a time division duplex (TDD) multi-pattern frame structure. The method is performed by a network device and includes: sending a first common signaling based on a first TDD frame structure and sending a second common signaling based on a second TDD frame structure; and receiving a first uplink (UL) signal sent by a terminal using the first TDD frame structure and receiving a second UL signal sent by a terminal using the second TDD frame structure, in which the first common signaling and the second UL signal are communicated via different frequency domain resources, and the second common signaling and the first UL signal are communicated via different frequency domain resources; and in which the second TDD frame structure and the first TDD frame structure have a same frame period and a same UL-downlink (DL) slot configuration, and the second TDD frame structure has a fixed frame header offset relative to the first TDD frame structure.

A second aspect of the present disclosure provides a method for interference avoiding based on a TDD multi-pattern frame structure. The method is performed by a terminal and includes: in a case that the terminal uses a first TDD frame structure, sending a first UL signal to a network device based on the first TDD frame structure and receiving a first common signaling sent by the network device; and in a case that the terminal uses a second TDD frame structure, sending a second UL signal to the network device based on the second TDD frame structure and receiving a second common signaling sent by the network device, in which the first common signaling and the second UL signal are communicated via different frequency domain resources, and the second common signaling and the first UL signal are communicated via different frequency domain resources; and in which the second TDD frame structure and the first TDD frame structure have a same frame period and a same UL-DL slot configuration, and the second TDD frame structure has a fixed frame header offset relative to the first TDD frame structure.

A third aspect of the present disclosure provides a network device. The network device includes: at least one processor; and a memory communicatively coupled to the at least one processor. The at least one processor is configured to send a first common signaling based on a first TDD frame structure and send a second common signaling based on a second TDD frame structure; and receive a first UL signal sent by a terminal using the first TDD frame structure and receive a second UL signal sent by a terminal using the second TDD frame structure, in which the first common signaling and the second UL signal are communicated via different frequency domain resources, and the second common signaling and the first UL signal are communicated via different frequency domain resources; and in which the second TDD frame structure and the first TDD frame structure have a same frame period and a same UL-DL slot configuration, and the second TDD frame structure has a fixed frame header offset relative to the first TDD frame structure.

### BRIEF DESCRIPTION OF THE DRAWINGS

The above and/or other aspects and advantages of the present disclosure may become apparent and more readily appreciated from the following descriptions of embodiments made with reference to the accompanying drawings.

FIG. 1 is a schematic diagram of a frame structure design scheme according to an embodiment of the present disclosure.

FIG. 2 is a schematic diagram of co-channel cross-link interference between UEs according to an embodiment of the present disclosure.

FIG. 3 is a schematic diagram of an implementation of a method for interference avoiding based on a time division duplex (TDD) multi-pattern frame structure according to an embodiment of the present disclosure.

FIG. 4 is a schematic diagram of a first adaptive design scheme according to an embodiment of the present disclosure.

FIG. 5 is a schematic diagram of an edge beam position and a non-edge beam position according to an embodiment of the present disclosure.

FIG. 6 is a schematic diagram of a slot occupied by a first uplink (UL) signal and a slot occupied by a second common signaling according to an embodiment of the present disclosure.

FIG. 7 is a schematic diagram of a slot occupied by a second UL signal and a slot occupied by a first common signaling according to an embodiment of the present disclosure.

FIG. 8 is a schematic diagram of a slot occupied by a second UL signal and a slot occupied by a first common signaling according to an embodiment of the present disclosure.

FIG. 9 is a schematic diagram of a second adaptive design scheme according to an embodiment of the present disclosure.

FIG. 10 is a schematic diagram of a slot occupied by a first UL signal and a slot occupied by a second common signaling according to the present disclosure.

FIG. 11 is a schematic diagram of a concept of a third adaptive design scheme according to the present disclosure.

FIG. 12 is a schematic diagram of a third adaptive design scheme according to the present disclosure.

FIG. 13 is a schematic diagram of generation of co-channel cross-link interference between UEs according to the present disclosure.

FIG. 14 is a schematic diagram of a method for interference avoiding based on a TDD multi-pattern frame structure according to the present disclosure.

FIG. 15 is a schematic diagram of an apparatus for interference avoiding based on a TDD multi-pattern frame structure according to the present disclosure.

FIG. 16 is a schematic diagram of an apparatus for interference avoiding based on a TDD multi-pattern frame structure according to the present disclosure.

FIG. 17 is a schematic diagram of a network device according to an embodiment of the present disclosure.

FIG. 18 is a schematic diagram of a terminal according to an embodiment of the present disclosure.

### DETAILED DESCRIPTION

Embodiments of the present disclosure are described in detail below. Examples of embodiments are shown in accompanying drawings, throughout which the same or similar labels represent the same or similar elements or elements having the same or similar functions. Embodiments below with reference to the accompanying drawings are illustrative and are intended to explain the present disclosure, but should not be construed as a limitation to the present disclosure.

To improve a radio interface resource utilization, in some implementations, terminals within a cell may be divided into two groups. One group of terminals is scheduled to use a basic time division duplex (TDD) frame structure, while another group of terminals is scheduled to use a frame-header-offset TDD frame structure. The two frame structures are identical in terms of a frame period and an uplink (UL)/ downlink (DL) slot configuration, with a difference lying in a frame header offset. This allows that, during a waiting period for communication between a network device and a group of terminals, the network device is able to communicate with another group of terminals, thus significantly improving a radio interface resource utilization of an entire system.

For convenience of description, in the present disclosure, the basic TDD frame structure may be referred to as a first TDD frame structure, and the frame-header-offset TDD frame structure may be referred to as a second TDD frame structure.

Three feasible frame structure design schemes are introduced below.

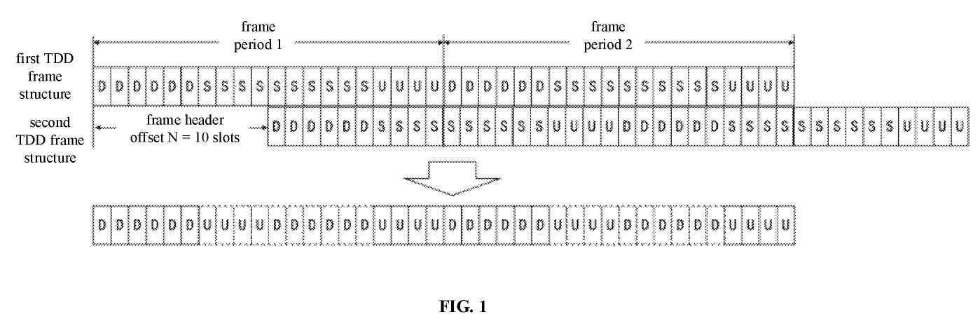

First feasible frame structure design scheme: FIG. 1 is a schematic diagram of a frame structure design scheme according to the present disclosure. As shown in FIG. 1, a first TDD frame structure is a basic frame structure. A numerical count of guard period (GP) slots in the first TDD frame structure is N (N is a positive integer). A sum of a numerical count of DL slots and a numerical count of UL slots in the first TDD frame structure equals to N. A frame header of the first TDD frame structure is offset by N slots to obtain a second TDD frame structure. In FIG. 1 and other figures in the present disclosure, “D” represents a DL slot, “U” represents a UL slot, and “S” represents a GP slot. As shown in FIG. 1, the DL slots and the UL slots of the second TDD frame structure correspond one-to-one with the GP slots of the first TDD frame structure. In a first frame structure design implementation, a network device may always communicate with some terminals, without a “must wait” period.

Second feasible frame structure design scheme: a first TDD frame structure is a basic frame structure. A numerical count of GP slots in the first TDD frame structure is N (N is a positive integer). A sum of a numerical count of DL slots and a numerical count of UL slots in the first TDD frame structure is less than N. A frame header of the first TDD frame structure is offset to obtain a second TDD frame structure.

Third feasible frame structure design scheme: a first TDD frame structure is a basic frame structure. A numerical count of GP slots in the first TDD frame structure is N (N is a positive integer). A sum of a numerical count of DL slots and a numerical count of UL slots in the first TDD frame structure is greater than N. A frame header of the first TDD frame structure is offset to obtain a second TDD frame structure.

In a TDD frame structure design described in the present disclosure, regardless of which a specific design scheme above is adopted, the frame header offset of the second TDD frame structure relative to the first TDD frame structure is configured as the sum of the numerical count of UL slots and the numerical count of DL slots in the first TDD frame structure, or the frame header offset is configured as the numerical count of GP slots in the first TDD frame structure.

Based on the frame structure implementation scheme designed above, when a plurality of TDD frame structures exist in the same cell, no conflict in a UL/DL direction occurs on any slot at a network device side. At a terminal side, no inter-terminal interference occurs between any two terminals in a set of terminals using the same frame structure (or between any two users belonging to the same user group).

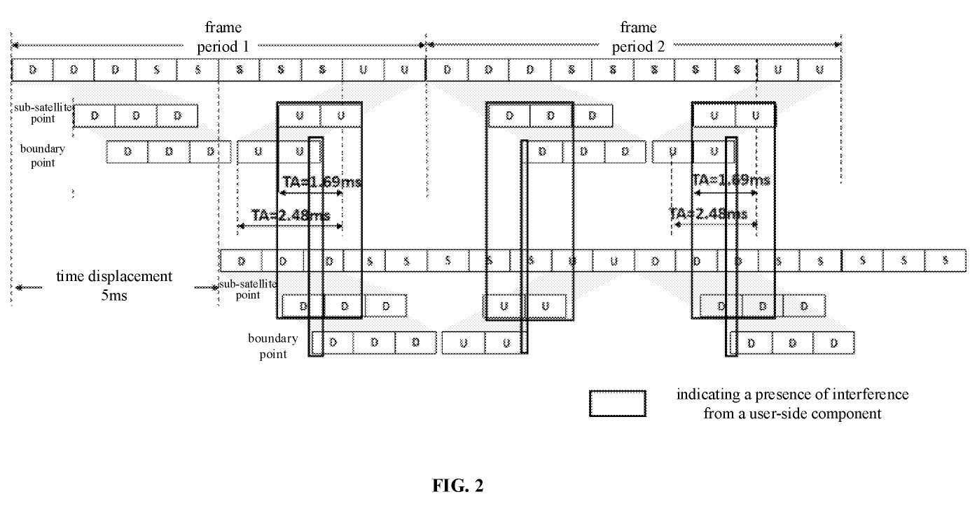

However, for example, as shown in FIG. 2, when two frame structures exist in the same cell, an excessively long propagation distance of a satellite-ground link requires a timing advance (TA) with a large value when the user performs UL transmission on the satellite-ground link, for example, the TA is 1.69 milliseconds or 2.48 milliseconds. A large magnitude of a transmission delay may exist for DL reception. Therefore, a situation may occur where one of “a terminal in a set of terminals using the basic TDD frame structure” and “a terminal in a set of terminals using the frame-header-offset TDD frame structure” is performing DL reception while another is performing UL transmission. If a distance between these two terminals is relatively close at this time, “co-channel cross-link interference between UEs” may occur. This newly introduced interference between different user groups at a user side, i.e., a terminal side, may be briefly referred to as “inter-group interference at the user side”. In FIG. 2, a sub-satellite point, for example, may be used to indicate an intersection point of a line connecting a satellite to a center of the Earth with a surface of the Earth. A boundary point, for example, may be used to indicate a farthest point within a coverage range of the satellite.

In other words, when the TDD mode is applied to satellite communication, a very long guard period (GP) needs to be reserved between a DL slot and a UL slot in each frame period, resulting in a quite low radio interface resource utilization for an entire system. In order to improve “network-side resource utilization” of the TDD mode, in the related art, user equipments (UEs) within a cell is divided into two groups, in which one group of UEs uses a basic TDD frame structure, and another group of UEs uses a frame-header-offset TDD frame structure. The two frame structures are identical in terms of a frame period and a configuration for a ratio between ULand DL slots, with a difference lying in a frame header offset. A technical effect of performing the frame header offset is to make “all (or a part) of DL slots and UL slots in a frame-header-offset frame structure” correspond to (i.e., occur at a same time as) “GP slots of a basic frame structure”, and naturally, also make “all (or a part) of DL slots and UL slots in a basic frame structure” correspond to the “GP slots of a frame-header-offset frame structure”. Therefore, a satellite-based base station may provide a communication service for a UE using the frame-header-offset frame structure during a time period corresponding to a GP slot of the basic frame structure, and may provide a communication service for a UE using the basic frame structure during a time period corresponding to a GP slot of the frame-header-offset frame structure. With the design, the “network-side resource utilization” may be significantly improved, thus enhancing application potential of the TDD mode in a satellite-ground link.

However, although a multi-pattern frame structure technology using the above two frame structures significantly improves the “network-side resource utilization” of the TDD satellite communication system, due to a long propagation distance of the satellite-ground link in the LEO satellite system, a timing advance (TA) with a large value is required when the user performs UL transmission on the satellite-ground link, and there may be a large magnitude of a transmission delay during UL reception. Therefore, when one group of UEs uses the basic TDD frame structure for communication and another group of UEs uses the frame-header-offset TDD frame structure for communication, two UEs belonging to different groups may encounter a following situation: one UE is performing DL reception while another UE is performing UL transmission. When a distance between the two UEs is relatively close, “co-channel cross-link interference between UEs” may be caused.

For the above “co-channel cross-link interference between UEs”, there is a specific interference scenario: potential co-channel cross-link interference that may exist between “a terminal that is transmitting a UL signal” and “a terminal that is receiving a necessary DL common signaling” within a cell. An interference avoiding strategy designed in the present disclosure for the interference scenario is described below.

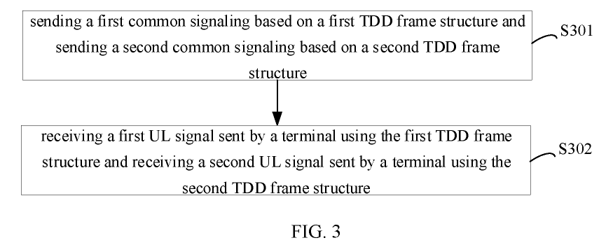

FIG. 3 is a schematic diagram of an implementation of a method for interference avoiding based on a TDD multi-pattern frame structure according to the present disclosure. As shown in FIG. 3, the method for interference avoiding based on a TDD multi-pattern frame structure is performed by a network device and includes following steps S301 to S302.

At S301, a first common signaling is sent based on a first TDD frame structure and a second common signaling is sent based on a second TDD frame structure.

In the present disclosure, a common signaling sent by the network device based on the first TDD frame structure is referred to as the first common signaling.

In the present disclosure, a common signaling sent by the network device based on the second TDD frame structure is referred to as the second common signaling.

The first common signaling and the second common signaling are both broadcast to a cell corresponding to the network device.

Based on an above introduction, the second TDD frame structure has a fixed frame header offset relative to the first TDD frame structure. Moreover, the second TDD frame structure and the first TDD frame structure have the same frame period and the same UL-DL slot configuration.

In an embodiment of the present disclosure, a name of the network device is not limited. For example, the network device may also be called as a base station or a satellite-based base station.

In an embodiment of the present disclosure, a technical solution of embodiments of the present disclosure may be used, for example, in a low earth orbit (LEO) satellite system. Specifically, it may be applied to, for example, an LEO satellite operating at an altitude of 600 kilometers.

At S302, a first UL signal sent by a terminal using the first TDD frame structure is received and a second UL signal sent by a terminal using the second TDD frame structure is received.

In the present disclosure, a UL signal received by the network device from a terminal using the first TDD frame structure is referred to as the first UL signal.

In the present disclosure, a UL signal received by the network device from a terminal using the second TDD frame structure is referred to as the second UL signal.

To avoid potential co-channel cross-link interference that may exist between “a terminal that is transmitting a UL signal” and “a terminal that is receiving a necessary DL common signaling” within a cell mentioned above, in the present disclosure, the first common signaling and the second UL signal are communicated via different frequency domain resources, and the second common signaling and the first UL signal are communicated via different frequency domain resources. This enables frequency domain isolation between a frequency domain resource used for a common signaling sent on one frame structure and a frequency domain resource used for a UL signal sent on another TDD frame structure, thus avoiding the potential co-channel cross-link interference that may exist between “a terminal that is transmitting a UL signal” and “a terminal that is receiving a necessary DL common signaling” within the cell.

In some implementations, the first common signaling is communicated via a first frequency domain resource, the second UL signal is communicated via a second frequency domain resource, and the first frequency domain resource and the second frequency domain resource are located in different subbands within a frequency band occupied by the network device for communicating a signal; and the second common signaling is communicated via a third frequency domain resource, the first UL signal is communicated via a fourth frequency domain resource, and the third frequency domain resource and the fourth frequency domain resource are located in different subbands within the frequency band occupied by the network device for communicating the signal. IIn this way, subband-level frequency domain isolation may be achieved between a frequency domain resource used for a common signaling sent on one frame structure and a frequency domain resource used for a UL signal sent on another TDD frame structure.

Furthermore, in the above description, although names of the first frequency domain resource and the third frequency domain resource are different, the first frequency domain resource and the third frequency domain resource may be the same frequency domain resource or different frequency domain resources.

Furthermore, in the above description, although names of the second frequency domain resource and the fourth frequency domain resource are different, the second frequency domain resource and the fourth frequency domain resource may be the same frequency domain resources or different frequency domain resources.

In some implementations, on the basis that the first frequency domain resource and the second frequency domain resource are located in different subbands within the frequency band occupied by the network device for communicating the signal, and the third frequency domain resource and the fourth frequency domain resource are located in different subbands within the frequency band occupied by the network device for communicating the signal, the network device performs a slot configuration using the following scheme: all of DL slots on the first TDD frame structure being configured to use the first frequency domain resource and all of UL slots on the second TDD frame structure being configured to use the second frequency domain resource. This may ensure that the DL slots occupied by the first common signaling and the UL slots occupied by the second UL signal occupy different frequency domain resources, thus guaranteeing subband-level frequency domain isolation between the first common signaling and the second UL signal. The DL slots on the second TDD frame structure and the UL slots on the first TDD frame structure may be configured using other frequency domain configuration schemes to achieve the subband-level frequency domain isolation between the second common signaling and the first UL signal.

In some implementations, on the basis that the first frequency domain resource and the second frequency domain resource are located in different subbands within the frequency band occupied by the network device for communicating the signal, and the third frequency domain resource and the fourth frequency domain resource are located in different subbands within the frequency band occupied by the network device for communicating the signal, the network device performs a slot configuration using the following scheme: all of DL slots on the second TDD frame structure being configured to use the third frequency domain resource and all of UL slots on the first TDD frame structure being configured to use the fourth frequency domain resource. This may ensure that the DL slots occupied by the second common signaling and the UL slots occupied by the first UL signal occupy different frequency domain resources, thus guaranteeing subband-level frequency domain isolation between the second common signaling and the first UL signal. The DL slots on the first TDD frame structure and the UL slots on the second TDD frame structure may be configured using other frequency domain configuration schemes to achieve the subband-level frequency domain isolation between the first common signaling and the second UL signal.

In some implementations, on the basis that the first frequency domain resource and the second frequency domain resource are located in different subbands within the frequency band occupied by the network device for communicating the signal, and the third frequency domain resource and the fourth frequency domain resource are located in different subbands within the frequency band occupied by the network device for communicating the signal, the network device performs a slot configuration using the following scheme: all of DL slots on the first TDD frame structure being configured to use the first frequency domain resource and all of UL slots on the second TDD frame structure being configured to use the second frequency domain resource; and all of DL slots on the second TDD frame structure being configured to use the third frequency domain resource and all of UL slots on the first TDD frame structure being configured to use the fourth frequency domain resource. This scheme is relatively simple and straightforward, which may ensure that the DL slots occupied by the first common signaling and the UL slots occupied by the second UL signal occupy different frequency domain resources, thus guaranteeing subband-level frequency domain isolation between the first common signaling and the second UL signal; and also ensures the DL slots occupied by the second common signaling and the UL slots occupied by the first UL signal occupy different frequency domain resources, thus guaranteeing subband-level frequency domain isolation between the second common signaling and the first UL signal.

It needs to be noted that when using the above frame structure design scheme, it is often necessary to adaptively design a communication scheme for the common signaling. Based on three adaptive design schemes, the following introduces an avoidance scheme for potential co-channel cross-link interference that may exist between “the terminal that is transmitting a UL signal” and “the terminal that is receiving a necessary DL common signaling” within the cell under each adaptive design scheme.

The three adaptive design schemes all follow a mechanism of separating a signaling beam from a service beam, which is typically adopted in an FDD mode.

In an introduction of the following three adaptive design schemes, the common signaling sent by the network device based on the first TDD frame structure is referred to as the first common signaling; the common signaling sent by the network device based on the second TDD frame structure is referred to as the second common signaling; the UL signal received by the network device from the terminal using the first TDD frame structure is referred to as the first UL signal; and the UL signal received by the network device from the terminal using the second TDD frame structure is referred to as the second UL signal. The second TDD frame structure is generated by offsetting the first TDD frame structure based on a fixed frame header offset, and the second TDD frame structure and the first TDD frame structure have the same frame period and the same UL-DL slot configuration.

### First adaptive design scheme

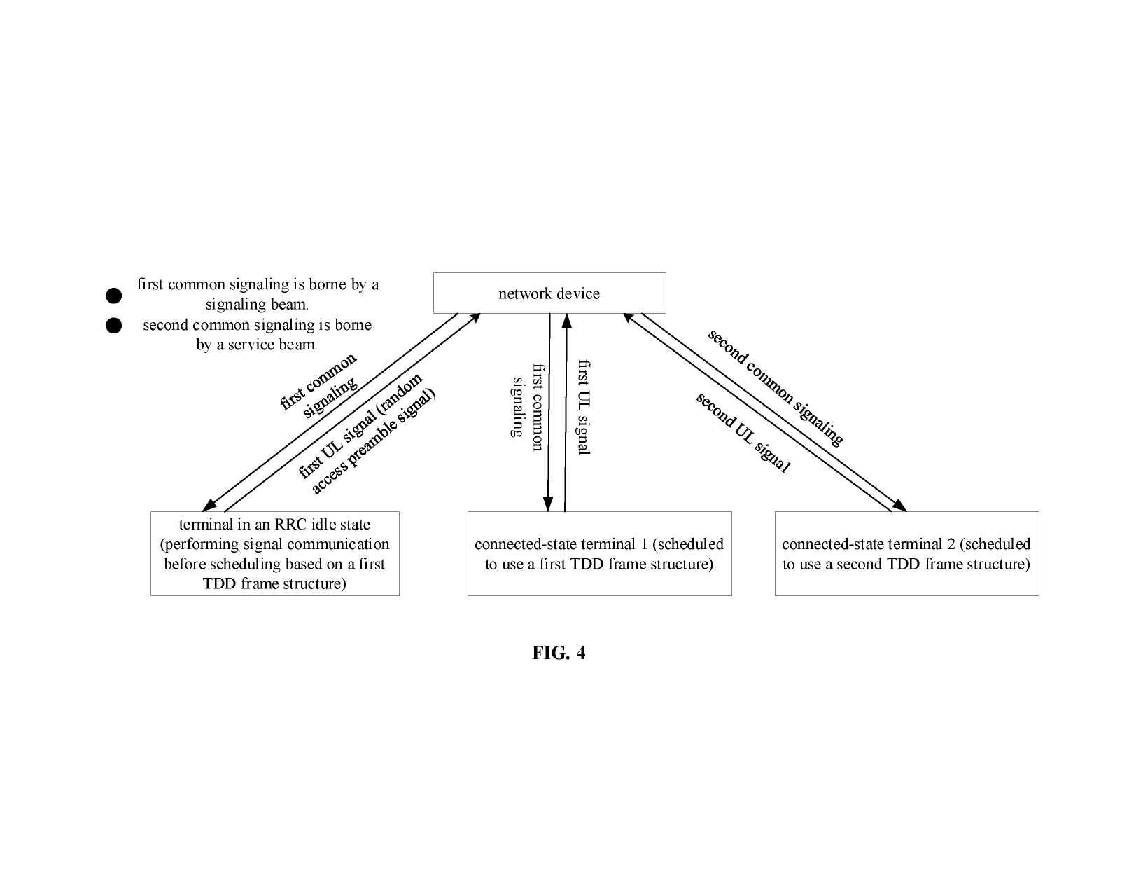

FIG. 4 is a schematic diagram of a first adaptive design scheme according to the present disclosure. As shown in FIG. 4, the network device configures one or more terminals in a radio resource control (RRC) idle state to perform signal communication before scheduling using the first TDD frame structure (the signal communication before scheduling at least includes: the terminal receiving a second common signaling broadcast by the network device before initiating initial random access, the terminal sending a random access preamble signal, and the terminal receiving a random access response sent by the network device).

After any terminal of the one or more terminals completes the signal communication before scheduling, the any terminal is configured to perform signal communication after scheduling using the first TDD frame structure or the any terminal is configured to perform signal communication after scheduling using the second TDD frame structure. Whether the any terminal is scheduled to perform the signal communication after scheduling using the first TDD frame structure or the second TDD frame structure after completing the signal communication before scheduling may adopt a scheme such as determination of grouping based on a beam position or other geographical isolation principles, or determination of grouping based on balancing a numerical count of UEs in two groups. The beam position represents a projection area of a beam on a ground. In a practical system, if a width of the signaling beam is greater than a width of the service beam, a projection area of the signaling beam on the ground is usually used to represent the beam position.

It is not difficult to understand that the network device sends the first common signaling to a cell based on the first TDD frame structure. After any terminal completes the signal communication before scheduling, the any terminal is configured to perform signal communication after scheduling using the first TDD frame structure (taking connected-state terminal 1 as an example in FIG. 4). In the signal communication after scheduling, the terminal still uses the first TDD frame structure to receive the first common signaling sent by the network device based on the first TDD frame structure, and, when the UL signal communication is needed, the terminal still sends the first UL signal to the network device based on the first TDD frame structure. Correspondingly, the network device may receive the first UL signal sent by the terminal using the first TDD frame structure.

It is not difficult to understand that the network device sends the second common signaling to a cell based on the second TDD frame structure. After any terminal completes the signal communication before scheduling, the any terminal is configured to perform the signal communication after scheduling using the second TDD frame structure (taking connected-state terminal 2 as an example in FIG. 4). In the signal communication after scheduling, the terminal uses the second TDD frame structure to receive the second common signaling sent by the network device based on the second TDD frame structure, and, when the UL signal communication is needed, the terminal sends the second UL signal to the network device based on the second TDD frame structure. Correspondingly, the network device may receive the second UL signal sent by the terminal using the second TDD frame structure.

In this embodiment, the first common signaling is borne by the signaling beam, and the second common signaling is borne by the service beam.

Depending on different networking modes of the network device and different positions, within a cell, of a beam position currently served by the signaling beam that bears the first common signaling, the first common signaling may include different signals. That is, it may be understood that the signal included in the first common signaling may be determined based on the networking mode of the network device and the position, within the cell, of the beam position currently served by the signaling beam that bears the first common signaling.

There may be two types of networking modes of the network device, one is that the network device adopts a networking mode that provides seamless full-area coverage using TDD, or the other one is that the network device adopts a networking mode that performs two-layer networking using frequency division duplex (FDD) and TDD (that is, the FDD is used as a network coverage layer for achieving full-area coverage, and the TDD is used as a network capacity layer for providing an on-demand capacity expansion service to a local area).

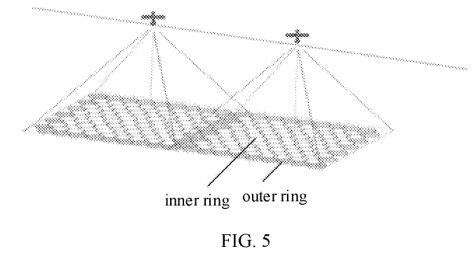

There are also two types of positions, within the cell, of the beam position currently served by the signaling beam that bears the first common signaling, one is an edge beam position, or the other one is a non-edge beam position. FIG. 5 is a schematic diagram of an edge beam position and a non-edge beam position according to the present disclosure. As shown in FIG. 5, the edge beam position and the non-edge beam position are determined according to a boundary of a coverage area of the network device and a preset distance threshold. That is, it may be understood that beam positions of the cell may be divided into an inner ring and an outer ring based on the boundary of the coverage area of the network device and the preset distance threshold. A beam position included in the outer ring are the edge beam position, and a beam position included in the inner ring is the non-edge beam position.

In some embodiments, in a case that the network device adopts the networking mode that provides the seamless full-area coverage using the TDD, and the position, within the cell, of the beam position currently served by the signaling beam that bears the first common signaling is the edge beam position, the first common signaling includes a cell-defining synchronization signal block (CD-SSB), a system information block 1 (SIB1) and other system information (OSI), in which the OSI at least includes SIB2, SIB3, SIB4, SIB6, SIB7, SIB8, or SIB19.

In some embodiments, in a case that the network device adopts the networking mode that provides the seamless full-area coverage using the TDD, and the position, within the cell, of the beam position currently served by the signaling beam that bears the first common signaling is the non-edge beam position, the first common signaling includes a CD-SSB, an SIB1 and OSI, in which the OSI at least includes SIB19.

In some embodiments, in a case that the network device adopts the networking mode that performs two-layer networking using the FDD and the TDD, and the signaling beam that bears the first common signaling currently serves any beam position of a TDD cell, the first common signaling includes a CD-SSB, an SIB1 and OSI, in which the OSI at least includes SIB2, SIB3, SIB4, SIB6, SIB7, SIB8, or SIB19.

SIB2, SIB3, and SIB4 mainly carry information related to intra-frequency cell reselection and inter-frequency cell reselection. SIB6, SIB7, and SIB8 mainly carry early warning information for natural disasters such as earthquakes and tsunamis. SIB19 carries ephemeris information.

SIB1 may be arranged to be sent in a slot immediately following the CD-SSB.

A frequency bandwidth occupied by the OSI usually does not exceed a frequency bandwidth occupied by SIB1. A frequency domain range of a radio interface resource for sending the OSI may be arranged as a subset of a frequency domain range of SIB1.

For any beam position, a number of times a first common signaling borne by the signaling beam appears in the DL slot of its corresponding first TDD frame structure is determined by a revisit period of the signaling beam to the any beam position, in which the signaling beam is used for broadcasting a synchronization signal and a system message and for initial access of the terminal, and the signaling beam provides a service to different beam positions using a time-division polling mechanism.

A second common signaling borne by the service beam only includes a non-cell-defining synchronization signal block (NCD-SSB), in which a period of sending the NCD-SSB is greater than or equal to a period of sending a CD-SSB borne by the signaling beam. A terminal scheduled to use the second TDD frame structure may complete measurement for radio resource management (RRM), radio link monitoring (RLM), and beam failure detection (BFD) by receiving the NCD-SSB.

When the first UL signal is a random access preamble signal (Msg 1), the UL slot occupied by the first UL signal in the first TDD frame structure is a time domain resource corresponding to a random access channel (RACH) occasion configured by the network device for a terminal using the first TDD frame structure. The first UL signal is communicated via a fourth frequency domain resource, the second common signaling borne by the service beam is communicated via a third frequency domain resource, and the third frequency domain resource and the fourth frequency domain resource are located in different subbands within the frequency band occupied by the network device for communicating the signal, to achieve subband-level frequency domain isolation between the second common signaling sent by the network device based on the second TDD frame structure and the first UL signal sent by the terminal based on the first TDD frame structure.

In this embodiment, the second UL signal is not the random access preamble signal, since the terminal is only possibly configured to use the second TDD frame structure after completing the signal communication before scheduling (including the terminal sending the random access preamble signal), and in this case, the signal communication before scheduling is completed, and transmitting of the random access preamble signal is not performed on the second TDD frame structure.

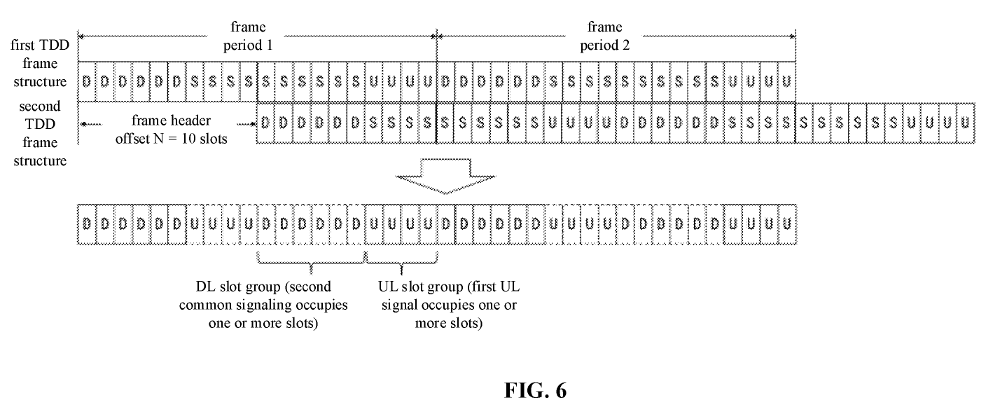

In a case that the first UL signal is a UL signal other than the random access preamble signal (for example, the first UL signal is a first UL signal sent by a connected-state terminal when configured to use the first TDD frame structure), and DL slots corresponding to the second common signaling within the second TDD frame structure belong to the same frame period (as introduced above, the second common signaling only includes the NCD-SSB, therefore the DL slots corresponding to the second common signaling in the second TDD frame structure certainly belong to the same frame period). FIG. 6 is a schematic diagram of a slot occupied by a first UL signal and a slot occupied by a second common signaling according to the present disclosure. As shown in FIG. 6, the first UL signal occupies at least one UL slot within a UL slot group of the first TDD frame structure, the DL slots corresponding to the second common signaling within the second TDD frame structure belong to one DL slot group, and the UL slot group is immediately after the DL slot group. The first UL signal and the second common signaling require subband-level frequency domain isolation. The second common signaling is communicated via a third frequency domain resource, the first UL signal is communicated via a fourth frequency domain resource, and the third frequency domain resource and the fourth frequency domain resource are located in different subbands within the frequency band occupied by the network device for communicating the signal, to achieve subband-level frequency domain isolation between the second common signaling sent by the network device based on the second TDD frame structure and the first UL signal sent by the terminal based on the first TDD frame structure.

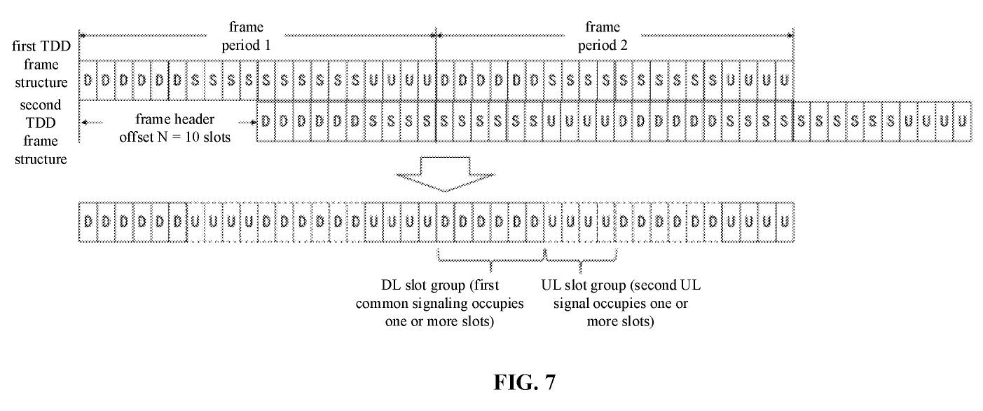

In a case that the second UL signal is a UL signal other than the random access preamble signal (for example, the second UL signal is a second UL signal sent by a connected-state terminal when configured to use the second TDD frame structure), and DL slots corresponding to the first common signaling within the first TDD frame structure belong to the same frame period (that is, DL slots corresponding to the CD-SSB, the SIB1, and the OSI included in the first common signaling in the first TDD frame structure as introduced above belong to the same frame period). FIG. 7 is a schematic diagram of a slot occupied by a second UL signal and a slot occupied by a first common signaling according to the present disclosure. As shown in FIG. 7, the second UL signal occupies at least one UL slot within a UL slot group of the second TDD frame structure, the DL slots corresponding to the first common signaling within the first TDD frame structure belong to one DL slot group, and the UL slot group is immediately after the DL slot group. The second UL signal and the first common signaling require subband-level frequency domain isolation. The first common signaling is communicated via a first frequency domain resource, the second UL signal is communicated via a second frequency domain resource, and the first frequency domain resource and the second frequency domain resource are located in different subbands within a frequency band occupied by the network device for communicating a signal, to achieve subband-level frequency domain isolation between the first common signaling sent by the network device based on the first TDD frame structure and the second UL signal sent by the terminal based on the second TDD frame structure.

Whether a period of sending the common signaling is the same as the frame period affects a frequency at which subband-level frequency division scheduling needs to be executed. For example, if a period of sending the CD-SSB is 20 ms (specifically, several transmissions occur within a first 5 ms of every 20 ms), a period of sending the first common signaling is 20 ms. If the frame period is extended to 20 ms, it is equivalent to requiring each set of consecutive UL slots in the second TDD frame structure to perform subband-level frequency domain isolation with the first common signaling. If the frame period remains 10 ms, only one set of every two sets of consecutive UL slots in the second TDD frame structure needs to perform subband-level frequency domain isolation with the first common signaling. As mentioned before, for the any beam position, the number of times the first common signaling borne by the signaling beam appears in the DL slot of its corresponding first TDD frame structure is determined by the revisit period of the signaling beam to the any beam position. Therefore, for a user in the any beam position that has an interference avoiding requirement, only at every interval of a revisit period of the beam position (typically tens or hundreds of milliseconds in a system configuring for a single satellite and a single cell), it is necessary to perform subband-level frequency domain isolation between a corresponding set of consecutive UL slots in the frame period of the second TDD frame structure and the first common signaling.

In a case that the second UL signal is a UL signal other than the random access preamble signal (for example, the second UL signal is a second UL signal sent by a connected-state terminal when configured to use the second TDD frame structure), and a plurality of parts of the first common signaling respectively occupy at least one DL slot within a plurality of DL slot groups that belongs to different frame periods within the first TDD frame structure (for example, the CD-SSB and the SIB1 included in the first common signaling are sent in frame period 1, while the OSI included in the first common signaling is sent in frame period 2 which is after and adjacent to frame period 1). FIG. 8 is a schematic diagram of a slot occupied by a second UL signal and a slot occupied by a first common signaling according to the present disclosure. As shown in FIG. 8, the second UL signal occupies at least one UL slot within a plurality of UL slot groups (UL slot group 1 and UL slot group 2) of the second TDD frame structure, respectively. The plurality of UL slot groups (UL slot group 1 and UL slot group 2) are immediately after the plurality of DL slot groups (DL slot group 1 and DL slot group 2) corresponding to the plurality of parts of the first common signaling, respectively. FIG. 8 schematically shows that a first part of the first common signaling and a second part of the first common signaling are sent in two frame periods, respectively. The first part of the first common signaling occupies one or more DL slots within DL slot group 1. The second part of the first common signaling occupies one or more DL slots within DL slot group 2. The second UL signal occupies one or more UL slots within UL slot group 1, which immediately follows DL slot group 1, and occupies one or more UL slots within UL slot group 2, which immediately follows DL slot group 2. The second UL signal and the first common signaling require subband-level frequency domain isolation. The first common signaling is communicated via a first frequency domain resource, the second UL signal is communicated via a second frequency domain resource, and the first frequency domain resource and the second frequency domain resource are located in different subbands within a frequency band occupied by the network device for communicating a signal, to achieve subband-level frequency domain isolation between the first common signaling sent by the network device based on the first TDD frame structure and the second UL signal sent by the terminal based on the second TDD frame structure.

### Second adaptive design scheme

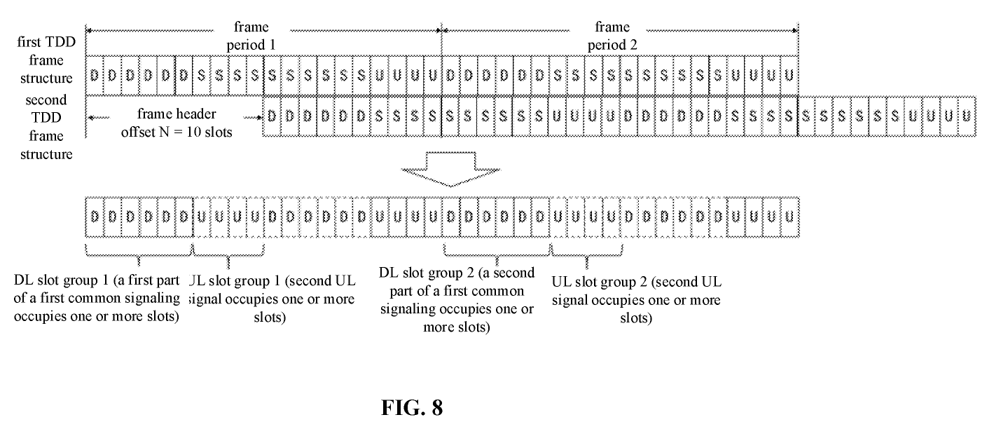

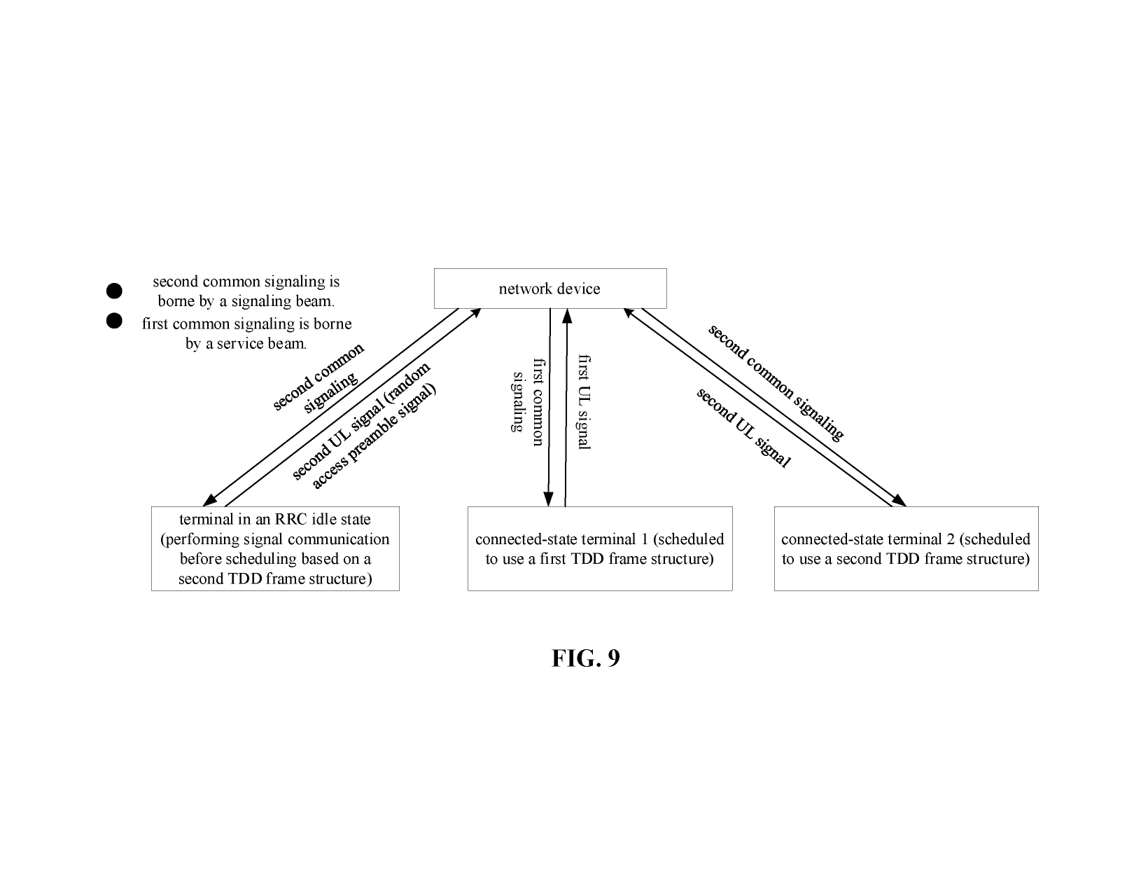

FIG. 9 is a schematic diagram of a second adaptive design scheme according to the present disclosure. As shown in FIG. 9, the network device configures one or more terminals in an RRC idle state to perform signal communication before scheduling using the second TDD frame structure (the signal communication before scheduling at least includes: the terminal receiving a first common signaling broadcast by the network device before initiating initial random access, the terminal sending a random access preamble signal, and the terminal receiving a random access response sent by the network device).

After any terminal of the one or more terminals completes the signal communication before scheduling, the any terminal is configured to perform signal communication after scheduling using the first TDD frame structure or the any terminal is configured to perform signal communication after scheduling using the second TDD frame structure. Whether the any terminal is scheduled to perform the signal communication after scheduling using the first TDD frame structure or the second TDD frame structure after completing the signal communication before scheduling may adopt a scheme such as determination of grouping based on a beam position or other geographical isolation principles, or determination of grouping based on balancing a numerical count of UEs in two groups.

It is not difficult to understand that the network device sends the first common signaling to a cell based on the first TDD frame structure. After any terminal completes the signal communication before scheduling, the any terminal is configured to perform signal communication after scheduling using the first TDD frame structure (taking connected-state terminal 1 as an example in FIG. 9). In the signal communication after scheduling, the terminal uses the first TDD frame structure to receive the first common signaling sent by the network device based on the first TDD frame structure, and, when the UL signal communication is needed, the terminal sends the first UL signal to the network device based on the first TDD frame structure. Correspondingly, the network device may receive the first UL signal sent by the terminal using the first TDD frame structure.

It is not difficult to understand that the network device sends the second common signaling to a cell based on the second TDD frame structure. After any terminal completes the signal communication before scheduling, the any terminal is configured to perform signal communication after scheduling using the second TDD frame structure (taking connected-state terminal 2 as an example in FIG. 9). In the signal communication after scheduling, the terminal uses the second TDD frame structure to receive the second common signaling sent by the network device based on the second TDD frame structure, and, when the UL signal communication is needed, the terminal sends the second UL signal to the network device based on the second TDD frame structure. Correspondingly, the network device may receive the second UL signal sent by the terminal using the second TDD frame structure.

In this embodiment, the first common signaling is borne by the service beam, and the second common signaling is borne by the signaling beam.

Depending on different networking modes of the network device and different positions, within a cell, of a beam position currently served by the signaling beam that bears the second common signaling, the second common signaling may include different signals. That is, it may be understood that the signal included in the second common signaling may be determined based on the networking mode of the network device and the position, within the cell, of the beam position currently served by the signaling beam that bears the second common signaling.

There may be two types of networking modes of the network device, one is that the network device adopts a networking mode that provides seamless full-area coverage using TDD, and the other one is that the network device adopts a networking mode that performs two-layer networking using FDD and TDD (that is, the FDD is used as a network coverage layer for achieving full-area coverage, and the TDD is used as a network capacity layer for providing an on-demand capacity expansion service to a local area).

There are also two types of positions, within the cell, of the beam position currently served by the signaling beam that bears the second common signaling, one is an edge beam position, or the other one is a non-edge beam position. The edge beam position and the non-edge beam position are determined according to a boundary of a coverage area of the network device and a preset distance threshold. For details, reference may be made to the description of FIG. 5.

In some embodiments, in a case that the network device adopts the networking mode that provides the seamless full-area coverage using the TDD, and the position, within the cell, of the beam position currently served by the signaling beam that bears the second common signaling is the edge beam position, the second common signaling includes a CD-SSB, an SIB1 and OSI, in which the OSI at least includes SIB2, SIB3, SIB4, SIB6, SIB7, SIB8, or SIB19.

In some embodiments, in a case that the network device adopts the networking mode that provides the seamless full-area coverage using the TDD, and the position, within the cell, of the beam position currently served by the signaling beam that bears the second common signaling is the non-edge beam position, the second common signaling includes a CD-SSB, an SIB1 and OSI, in which the OSI at least includes SIB19.

In some embodiments, in a case that the network device adopts the networking mode that performs two-layer networking using the FDD and the TDD, and the signaling beam that bears the second common signaling currently serves any beam position of a TDD cell, the second common signaling includes a CD-SSB, an SIB1 and OSI, in which the OSI at least includes SIB2, SIB3, SIB4, SIB6, SIB7, SIB8, or SIB19.

SIB2, SIB3, and SIB4 mainly carry information related to intra-frequency cell reselection and inter-frequency cell reselection. SIB6, SIB7, and SIB8 mainly carry early warning information for natural disasters such as earthquakes and tsunamis. SIB19 carries ephemeris information.

SIB1 may be arranged to be sent in a slot immediately following the CD-SSB.

A frequency bandwidth occupied by the OSI usually does not exceed a frequency bandwidth occupied by SIB1. A frequency domain range of a radio interface resource for sending the OSI may be arranged as a subset of a frequency domain range of SIB1.

For any beam position, a number of times a second common signaling borne by the signaling beam appears in the DL slot of its corresponding second TDD frame structure is determined by a revisit period of the signaling beam to the any beam position, in which the signaling beam is used for broadcasting a synchronization signal and a system message and for initial access of the terminal, and the signaling beam provides a service to different beam positions using a time-division polling mechanism.

A first common signaling borne by the service beam only includes an NCD-SSB, in which a period of sending the NCD-SSB is greater than or equal to a period of sending a CD-SSB borne by the signaling beam. A terminal scheduled to use the first TDD frame structure may complete measurement for RRM, RLM, and BFD by receiving the NCD-SSB.

When the second UL signal is a random access preamble signal, the UL slot occupied by the second UL signal in the second TDD frame structure is a time domain resource corresponding to a RACH occasion configured by the network device for a terminal using the second TDD frame structure. The second UL signal is communicated via a second frequency domain resource, the first common signaling borne by the service beam is communicated via a first frequency domain resource, and the first frequency domain resource and the second frequency domain resource are located in different subbands within the frequency band occupied by the network device for communicating the signal, to achieve subband-level frequency domain isolation between the first common signaling sent by the network device based on the first TDD frame structure and the second UL signal sent by the terminal based on the second TDD frame structure.

In this embodiment, the first UL signal is not the random access preamble signal, since the terminal is only possibly configured to use the first TDD frame structure after completing the signal communication before scheduling (including the terminal sending the random access preamble signal), and in this case, the signal communication before scheduling is completed, and transmitting of the random access preamble signal is not performed on the first TDD frame structure.

In a case that the first UL signal is a UL signal other than the random access preamble signal (for example, the first UL signal is a first UL signal sent by a connected-state terminal when configured to use the first TDD frame structure), and DL slots corresponding to the second common signaling within the second TDD frame structure belong to the same frame period (DL slots corresponding to the CD-SSB, the SIB1, and the OSI included in the second common signaling in the second TDD frame structure as introduced above belong to the same frame period), the first UL signal occupies at least one UL slot within a UL slot group of the first TDD frame structure, the DL slots corresponding to the second common signaling within the second TDD frame structure belong to one DL slot group, and the UL slot group is immediately after the DL slot group. For a detailed description, reference may be made to FIG. 6, and the only difference is signal content included in the second common signaling, while the idea is the same when designing. The first UL signal and the second common signaling require subband-level frequency domain isolation. The second common signaling is communicated via a third frequency domain resource, the first UL signal is communicated via a fourth frequency domain resource, and the third frequency domain resource and the fourth frequency domain resource are located in different subbands within the frequency band occupied by the network device for communicating the signal, to achieve subband-level frequency domain isolation between the second common signaling sent by the network device based on the second TDD frame structure and the first UL signal sent by the terminal based on the first TDD frame structure.

In a case that the second UL signal is a UL signal other than the random access preamble signal (for example, the second UL signal is a second UL signal sent by a connected-state terminal when configured to use the second TDD frame structure), and DL slots corresponding to the first common signaling within the first TDD frame structure belong to the same frame period (as described above, the first common signaling only includes the NCD-SSB, therefore the DL slots corresponding to the first common signaling in the first TDD frame structure certainly belong to the same frame period), the second UL signal occupies at least one UL slot within a UL slot group of the second TDD frame structure, the DL slots corresponding to the first common signaling within the first TDD frame structure belong to one DL slot group, and the UL slot group is immediately after the DL slot group. For a detailed description, reference may be made to FIG. 7, and the only difference is signal content included in the first common signaling, while the idea is the same when designing. The second UL signal and the first common signaling require subband-level frequency domain isolation. The first common signaling is communicated via a first frequency domain resource, the second UL signal is communicated via a second frequency domain resource, and the first frequency domain resource and the second frequency domain resource are located in different subbands within a frequency band occupied by the network device for communicating a signal, to achieve subband-level frequency domain isolation between the first common signaling sent by the network device based on the first TDD frame structure and the second UL signal sent by the terminal based on the second TDD frame structure.

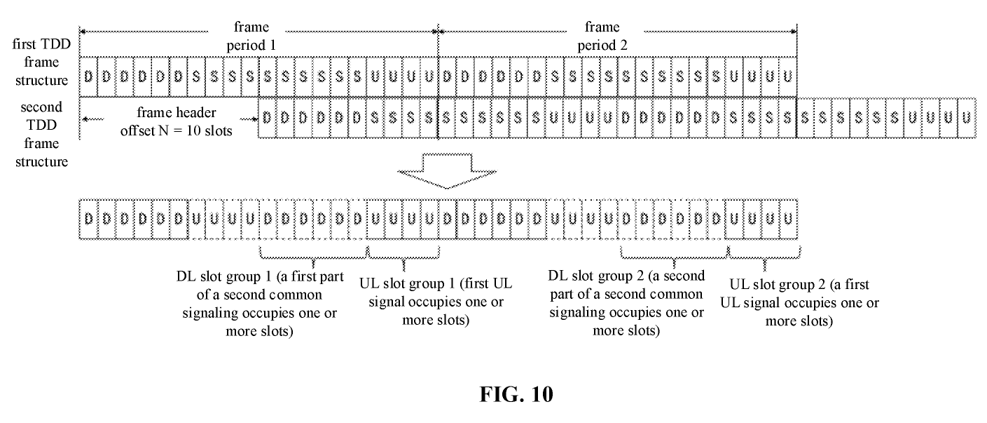

In a case that the first UL signal is a UL signal other than the random access preamble signal (for example, the first UL signal is a first UL signal sent by a connected-state terminal when configured to use the first TDD frame structure), and a plurality of parts of the second common signaling respectively occupy at least one DL slot within a plurality of DL slot groups that belongs to different frame periods within the second TDD frame structure (for example, the CD-SSB and the SIB1 included in the second common signaling are sent in frame period 1, while the OSI included in the second common signaling is sent in frame period 2 which is after and adjacent to frame period 1). FIG. 10 is a schematic diagram of a slot occupied by a first UL signal and a slot occupied by a second common signaling according to the present disclosure. As shown in FIG. 10, the first UL signal occupies at least one UL slot within a plurality of UL slot groups (UL slot group 1 and UL slot group 2) of the first TDD frame structure, respectively. The plurality of UL slot groups (UL slot group 1 and UL slot group 2) are immediately after the plurality of DL slot groups (DL slot group 1 and DL slot group 2) corresponding to the plurality of parts of the second common signaling, respectively. FIG. 10 schematically shows that a first part of the second common signaling and a second part of the second common signaling are sent in two frame periods, respectively. The first part of the second common signaling occupies one or more DL slots within DL slot group 1. The second part of the second common signaling occupies one or more DL slots within DL slot group 2. The first UL signal occupies one or more UL slots within UL slot group 1, which immediately follows DL slot group 1, and occupies one or more UL slots within UL slot group 2, which immediately follows DL slot group 2. The first UL signal and the second common signaling require subband-level frequency domain isolation. The second common signaling is communicated via a third frequency domain resource, the first UL signal is communicated via a fourth frequency domain resource, and the third frequency domain resource and the fourth frequency domain resource are located in different subbands within a frequency band occupied by the network device for communicating the signal, to achieve subband-level frequency domain isolation between the second common signaling sent by the network device based on the second TDD frame structure and the first UL signal sent by the terminal based on the first TDD frame structure.

### Third adaptive design scheme

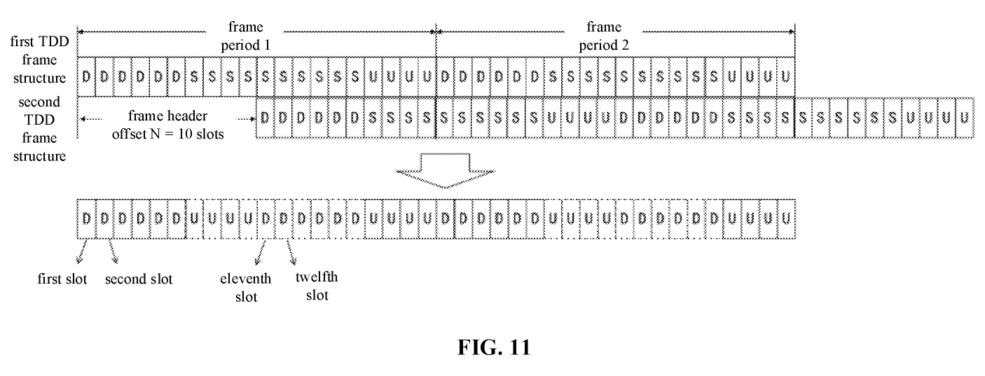

FIG. 11 is a schematic diagram of a concept of a third adaptive design scheme according to the present disclosure, which is for illustration only. According to a definition in a 3GPP protocol for a configuration of an SSB signal in a DL common signaling, when a commonly used Case C SSB configuration is adopted, for any given frame structure, at a transmission occasion of the CD-SSB, within every duration of 20 ms, the CD-SSB is transmitted in first four slots (of course, it does not mean that the CD-SSB should be sent in every slot of the first four slots). Therefore, when an SSB is sent in first k (k<=4) slots every 20 ms calculated from a frame header of the first TDD frame structure, and simultaneously, an SSB is sent in first k (k<=4) slots every 20 ms calculated from a frame header of the second TDD frame structure, SSBs sent on the two frame structures are staggered in a time domain and do not affect each other. Taking the first feasible frame structure design scheme above as an example (assumed that a frame period is 10 ms, subcarrier spacing is 30 kHz, a numerical count of GP slots in the first TDD frame structure N = 10, a sum of a numerical count of DL slots and a numerical count of UL slots in the first TDD frame structure equals to N, and a length of a frame header offset in the second TDD frame structure N = 10 slots), when an SSB is sent in first two slots every 20 ms calculated from the frame header of the first TDD frame structure, and simultaneously, an SSB is sent in first two slots every 20 ms calculated from the frame header of the second TDD frame structure, from a perspective of the satellite--based base station, when the first TDD frame structure and the second TDD frame structure are not distinguished but available slots are only counted, in this examples, based on a first round of SSB transmission on the first TDD frame structure and the second TDD frame structure, the CD-SSB is communicated in the 1st, 2nd, 11th, and 12th available slots.

Based on the above design idea, it may be designed in the present disclosure that the first common signaling is arranged to be sent in the DL slot of the first TDD frame structure, and the second common signaling is arranged to be sent in the DL slot of the second TDD frame structure. Both the first common signaling and the second common signaling are borne by signaling beams.

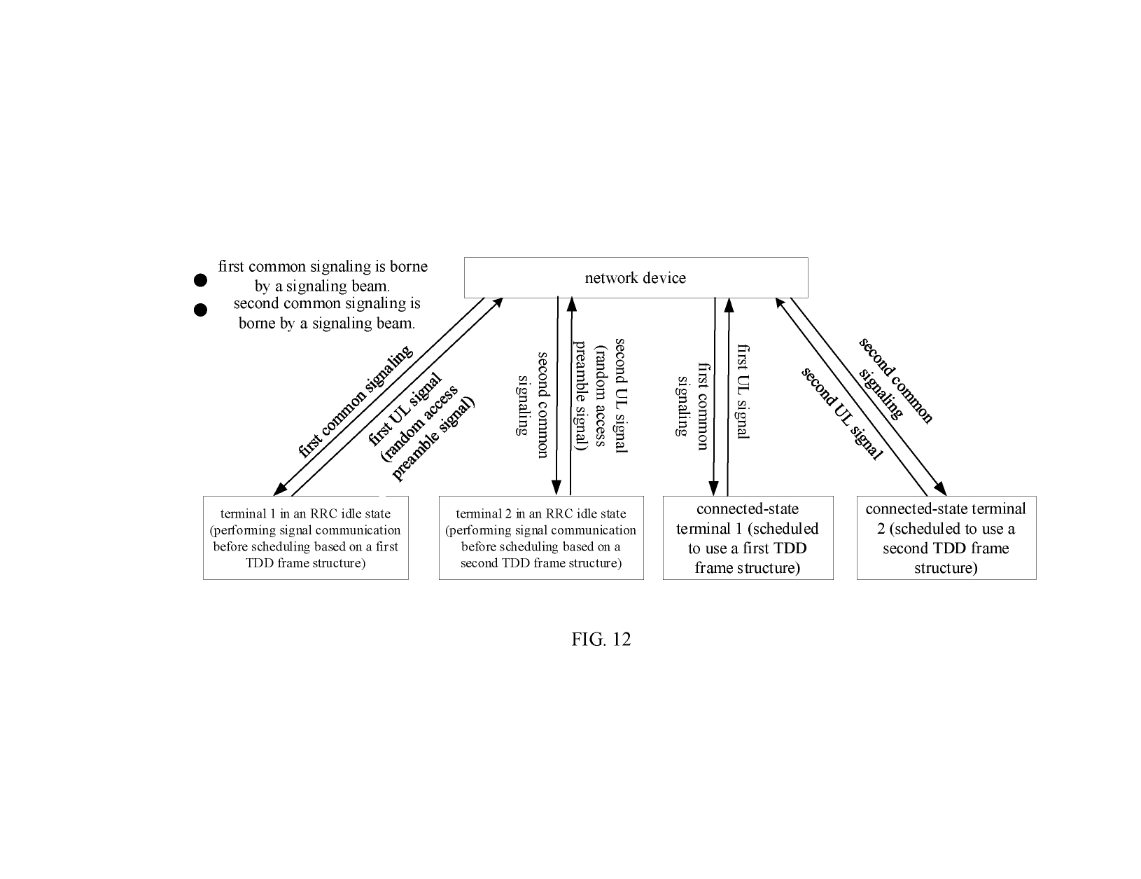

FIG. 12 is a schematic diagram of a third adaptive design scheme according to the present disclosure. As shown in FIG. 12, the network device configures a first part of terminals among a plurality of terminals, within a cell covered by the network device, that are in an RRC idle state to perform signal communication before scheduling using the first TDD frame structure (the signal communication before scheduling at least includes: the terminal receiving a first common signaling broadcast by the network device before initiating initial random access, the terminal sending a random access preamble signal, and the terminal receiving a random access response sent by the network device). After any terminal in the first part of terminals completes the signal communication before scheduling, the network device configures that the any terminal is configured to perform signal communication after scheduling using the first TDD frame structure or the second TDD frame structure. Or, after any terminal in the first part of terminals completes the signal communication before scheduling, the network device configures that the any terminal is configured to perform signal communication after scheduling using a TDD frame structure the same as a TDD frame structure used in a case of performing the signal communication before scheduling (i.e., the first TDD frame structure).

As shown in FIG. 12, the network device configures a second part of terminals among a plurality of terminals, within a cell covered by the network device, that are in an RRC idle state to perform signal communication before scheduling using the second TDD frame structure (the signal communication before scheduling at least includes: the terminal receiving a second common signaling broadcast by the network device before initiating initial random access, the terminal sending a random access preamble signal, and the terminal receiving a random access response sent by the network device). After any terminal in the second part of terminals completes the signal communication before scheduling, the any terminal is configured to perform signal communication after scheduling using the first TDD frame structure or the second TDD frame structure. Or, after any terminal in the first part of terminals completes the signal communication before scheduling, the any terminal is configured to perform signal communication after scheduling using a TDD frame structure the same as a TDD frame structure used in a case of performing the signal communication before scheduling (i.e., the second TDD frame structure).

The first part of terminals in the RRC idle state and the second part of terminals in the RRC idle state together constitute all of terminals in the RRC idle state within the cell covered by the network device. A division of the first part and the second part may be performed according to a beam position, or may be balanced according to a numerical count of terminals, or may be performed according to other principles such as a random principle. In an embodiment, if the division of the first part and the second part is performed according to the beam position, after any terminal completes the signal communication before scheduling, in a case that the terminal does not change its beam position due to its own mobility, the terminal is configured to use a TDD frame structure the same as the TDD frame structure used in a case of performing the signal communication before scheduling, when performing the signal communication after scheduling.

It is not difficult to understand that the network device sends the first common signaling to a cell based on the first TDD frame structure. After any terminal completes the signal communication before scheduling, the any terminal is configured to perform signal communication after scheduling using the first TDD frame structure (taking connected-state terminal 1 as an example in FIG. 12). In the signal communication after scheduling, the terminal uses the first TDD frame structure to receive the first common signaling sent by the network device based on the first TDD frame structure, and, when the UL signal communication is needed, the terminal still sends the first UL signal to the network device based on the first TDD frame structure. Correspondingly, the network device may receive the first UL signal sent by the terminal using the first TDD frame structure.

It is not difficult to understand that the network device sends the second common signaling to a cell based on the second TDD frame structure. After any terminal completes the signal communication before scheduling, the any terminal is configured to perform signal communication after scheduling using the second TDD frame structure (taking connected-state terminal 2 as an example in FIG. 12). In the signal communication after scheduling, the terminal uses the second TDD frame structure to receive the second common signaling sent by the network device based on the second TDD frame structure, and, when the UL signal communication is needed, the terminal sends the second UL signal to the network device based on the second TDD frame structure. Correspondingly, the network device may receive the second UL signal sent by the terminal using the second TDD frame structure.

Depending on different networking modes of the network device and different positions, within a cell, of a beam position currently served by the signaling beam that bears the first common signaling or the second common signaling, the first common signaling or the second common signaling may include different signals. That is, it may be understood that the signal included in the first common signaling or the second common signaling may be determined based on the networking mode of the network device and the position, within the cell, of the beam position currently served by the signaling beam that bears the first common signaling or the second common signaling.

There may be two types of networking modes of the network device, one is that the network device adopts a networking mode that provides seamless full-area coverage using TDD, or the other one is that the network device adopts a networking mode that performs two-layer networking using FDD and TDD (that is, the FDD is used as a network coverage layer for achieving full-area coverage, and the TDD is used as a network capacity layer for providing an on-demand capacity expansion service to a local area).

There are also two types of positions, within the cell, of the beam position currently served by the signaling beam that bears the first common signaling or the second common signaling, one is an edge beam position, or the other one is a non-edge beam position. The edge beam position and the non-edge beam position are determined according to a boundary of a coverage area of the network device and a preset distance threshold.

In some embodiments, in a case that the network device adopts the networking mode that provides the seamless full-area coverage using the TDD, and the position, within the cell, of the beam position currently served by the signaling beam that bears the first common signaling is the edge beam position, the first common signaling includes a CD-SSB, an SIB1 and OSI, in which the OSI at least includes SIB2, SIB3, SIB4, SIB6, SIB7, SIB8, or SIB19.

In some embodiments, in a case that the network device adopts the networking mode that provides the seamless full-area coverage using the TDD, and the position, within the cell, of the beam position currently served by the signaling beam that bears the second common signaling is the edge beam position, the second common signaling includes a CD-SSB, an SIB1 and OSI, in which the OSI at least includes SIB2, SIB3, SIB4, SIB6, SIB7, SIB8, or SIB19.

In some embodiments, in a case that the network device adopts the networking mode that provides the seamless full-area coverage using the TDD, and the position, within the cell, of the beam position currently served by the signaling beam that bears the first common signaling is the non-edge beam position, the first common signaling includes a CD-SSB, an SIB1 and OSI, in which the OSI at least includes SIB19.

In some embodiments, in a case that the network device adopts the networking mode that provides the seamless full-area coverage using the TDD, and the position, within the cell, of the beam position currently served by the signaling beam that bears the second common signaling is the non-edge beam position, the second common signaling includes a CD-SSB, an SIB1 and OSI, in which the OSI at least includes SIB19.

In some embodiments, in a case that the network device adopts the networking mode that performs two-layer networking using the FDD and the TDD, and the signaling beam that bears the first common signaling currently serves any beam position of a TDD cell, the first common signaling includes a CD-SSB, an SIB1 and OSI, in which the OSI at least includes SIB2, SIB3, SIB4, SIB6, SIB7, SIB8, or SIB19.

In some embodiments, in a case that the network device adopts the networking mode that performs two-layer networking using the FDD and the TDD, and the signaling beam that bears the second common signaling currently serves any beam position of a TDD cell, the second common signaling includes a CD-SSB, an SIB1 and OSI, in which the OSI at least includes SIB2, SIB3, SIB4, SIB6, SIB7, SIB8, or SIB19.

SIB2, SIB3, and SIB4 mainly carry information related to intra-frequency cell reselection and inter-frequency cell reselection; SIB6, SIB7, and SIB8 mainly carry early warning information for natural disasters such as earthquakes and tsunamis. SIB19 carries ephemeris information.

SIB1 may be arranged to be sent in a slot immediately following the CD-SSB.

A frequency bandwidth occupied by the OSI usually does not exceed a frequency bandwidth occupied by SIB1. A frequency domain range of a radio interface resource for sending the OSI may be arranged as a subset of a frequency domain range of SIB1.

For any beam position, a number of times a first common signaling borne by the signaling beam appears in the DL slot of its corresponding first TDD frame structure is determined by a revisit period of the signaling beam to the any beam position, in which the signaling beam is used for broadcasting a synchronization signal and a system message and for initial access of the terminal, and the signaling beam provides a service to different beam positions using a time-division polling mechanism.

For any beam position, a number of times a second common signaling borne by the signaling beam appears in the DL slot of its corresponding second TDD frame structure is determined by a revisit period of the signaling beam to the any beam position, in which the signaling beam is used for broadcasting a synchronization signal and a system message and for initial access of the terminal, and the signaling beam provides a service to different beam positions using a time-division polling mechanism.

When the first UL signal is a random access preamble signal, the UL slot occupied by the first UL signal in the first TDD frame structure is a time domain resource corresponding to a RACH occasion configured by the network device for a terminal using the first TDD frame structure. The first UL signal is communicated via a fourth frequency domain resource, the second common signaling is communicated via a third frequency domain resource, and the third frequency domain resource and the fourth frequency domain resource are located in different subbands within the frequency band occupied by the network device for communicating the signal, to achieve subband-level frequency domain isolation between the second common signaling sent by the network device based on the second TDD frame structure and the first UL signal sent by the terminal based on the first TDD frame structure.

When the second UL signal is the random access preamble signal, the UL slot occupied by the second UL signal in the second TDD frame structure is a time domain resource corresponding to a RACH occasion configured by the network device for a terminal using the second TDD frame structure. The second UL signal is communicated via a second frequency domain resource, the first common signaling is communicated via a first frequency domain resource, and the first frequency domain resource and the second frequency domain resource are located in different subbands within the frequency band occupied by the network device for communicating the signal, to achieve subband-level frequency domain isolation between the first common signaling sent by the network device based on the first TDD frame structure and the second UL signal sent by the terminal based on the second TDD frame structure.

In a case that the first UL signal is a UL signal other than the random access preamble signal (for example, the first UL signal is a first UL signal sent by a connected-state terminal when configured to use the first TDD frame structure), and DL slots corresponding to the second common signaling within the second TDD frame structure belong to the same frame period (DL slots corresponding to the CD-SSB, the SIB1, and the OSI included in the second common signaling in the second TDD frame structure as introduced above belong to the same frame period), the first UL signal occupies at least one UL slot within a UL slot group of the first TDD frame structure, the DL slots corresponding to the second common signaling within the second TDD frame structure belong to one DL slot group, and the UL slot group is immediately after the DL slot group. For a detailed description, reference may be made to FIG. 6. An idea is the same when designing, except that it differs from the signal included in the second common signaling in FIG. 6. The first UL signal and the second common signaling require subband-level frequency domain isolation. The second common signaling is communicated via a third frequency domain resource, the first UL signal is communicated via a fourth frequency domain resource, and the third frequency domain resource and the fourth frequency domain resource are located in different subbands within the frequency band occupied by the network device for communicating the signal, to achieve subband-level frequency domain isolation between the second common signaling sent by the network device based on the second TDD frame structure and the first UL signal sent by the terminal based on the first TDD frame structure.

In a case that the second UL signal is a UL signal other than the random access preamble signal (for example, the second UL signal is a second UL signal sent by a connected-state terminal when configured to use the second TDD frame structure), and DL slots corresponding to the first common signaling within the first TDD frame structure belong to the same frame period (DL slots corresponding to the CD-SSB, the SIB1, and the OSI included in the first common signaling in the first TDD frame structure as introduced above belong to the same frame period), the second UL signal occupies at least one UL slot within a UL slot group of the second TDD frame structure, the DL slots corresponding to the first common signaling within the first TDD frame structure belong to one DL slot group, and the UL slot group is immediately after the DL slot group. For a detailed description, reference may be made to FIG. 7. An idea is the same when designing. The second UL signal and the first common signaling require subband-level frequency domain isolation. The first common signaling is communicated via a first frequency domain resource, the second UL signal is communicated via a second frequency domain resource, and the first frequency domain resource and the second frequency domain resource are located in different subbands within the frequency band occupied by the network device for communicating the signal, to achieve subband-level frequency domain isolation between the first common signaling sent by the network device based on the first TDD frame structure and the second UL signal sent by the terminal based on the second TDD frame structure.

In a case that the second UL signal is a UL signal other than the random access preamble signal (for example, the second UL signal is a second UL signal sent by a connected-state terminal when configured to use the second TDD frame structure), and a plurality of parts of the first common signaling respectively occupy at least one DL slot within a plurality of DL slot groups that belongs to different frame periods within the first TDD frame structure (for example, the CD-SSB and the SIB1 included in the first common signaling are sent in frame period 1, while the OSI included in the first common signaling is sent in frame period 2 which is after and adjacent to frame period 1), the second UL signal occupies at least one UL slot within a plurality of UL slot groups of the second TDD frame structure, respectively, and the plurality of UL slot groups are immediately after the plurality of DL slot groups, respectively. For a detailed description, reference may be made to FIG. 8. An idea is the same when designing. The second UL signal and the first common signaling require subband-level frequency domain isolation. The first common signaling is communicated via a first frequency domain resource, the second UL signal is communicated via a second frequency domain resource, and the first frequency domain resource and the second frequency domain resource are located in different subbands within the frequency band occupied by the network device for communicating the signal, to achieve subband-level frequency domain isolation between the first common signaling sent by the network device based on the first TDD frame structure and the second UL signal sent by the terminal based on the second TDD frame structure.

In a case that the first UL signal is
a UL signal other than the random access preamble signal (for example, the first UL signal is a first UL signal sent by a connected-state terminal when configured to use the first TDD frame structure), and a plurality of parts of the second common signaling respectively occupy at least one DL slot within a plurality of DL slot groups that belongs to different frame periods within the second TDD frame structure (for example, the CD-SSB and the SIB1 included in the second common signaling are sent in frame period 1, while the OSI included in the second common signaling is sent in frame period 2 which is after and adjacent to frame period 1), the first UL signal occupies at least one UL slot within a plurality of UL slot groups of the first TDD frame structure, respectively, and the plurality of UL slot groups are immediately after the plurality of DL slot groups corresponding to the plurality of parts of the second common signaling, respectively. For a detailed description, reference may be made to FIG. 10. An idea is the same when designing. The first UL signal and the second common signaling require subband-level frequency domain isolation. The second common signaling is communicated via a third frequency domain resource, the first UL signal is communicated via a fourth frequency domain resource, and the third frequency domain resource and the fourth frequency domain resource are located in different subbands within a frequency band occupied by the network device for communicating the signal, to achieve subband-level frequency domain isolation between the second common signaling sent by the network device based on the second TDD frame structure and the first UL signal sent by the terminal based on the first TDD frame structure.

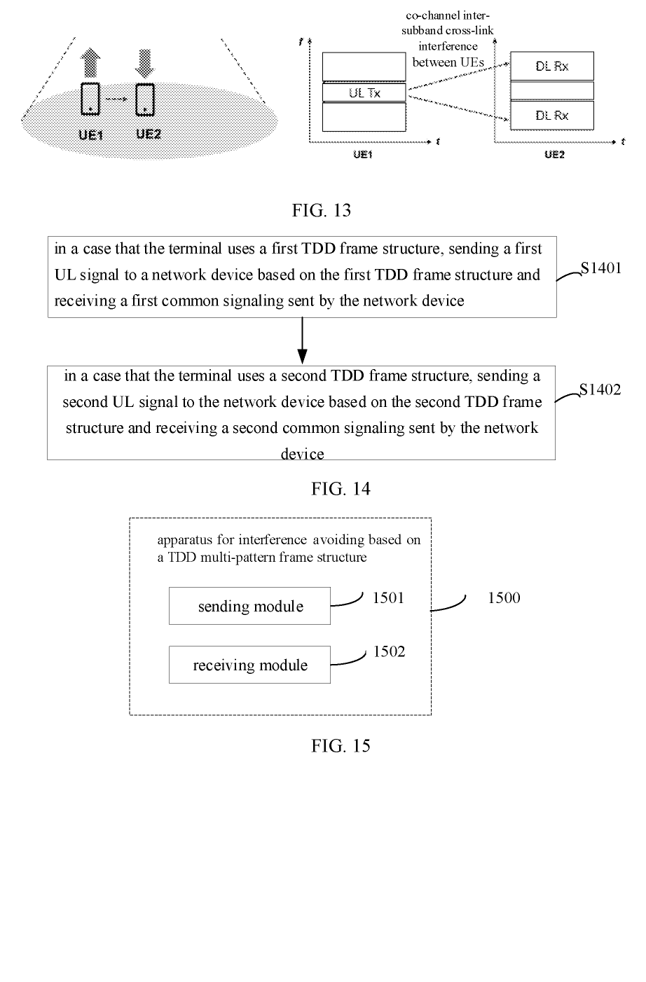

When any one of the above three adaptive design schemes is adopted to perform interference avoidance based on subband-level frequency domain isolation for potential co-channel cross-link interference that may exist between “the terminal that is transmitting a UL signal using a type of TDD frame structures” and “the terminal that is receiving a necessary DL common signaling using another type of TDD frame structure” within the cell, and corresponding signal transmission and reception are indeed performed, there may be residual co-channel inter-subband cross-link interference between UEs. FIG. 13 is a schematic diagram illustrating generation of co-channel inter-subband cross-link interference between UEs according to the present disclosure. The present disclosure may coordinate scheduling of the terminal based on physical layer L1 measurement or network layer L3 measurement on interference, thus eliminating the residual co-channel inter-subband cross-link interference between UEs, or, an advanced UE receiver may be used to eliminate the residual co-channel inter-subband cross-link interference between UEs.

Furthermore, when each network device avoids potential co-channel cross-link interference that may exist between “the terminal that is transmitting a UL signal” and “the terminal that is receiving a necessary DL common signaling” within the cell, if an adopted strategy is a design scheme described in the above embodiments of “enabling a frequency domain resource used for sending the DL common signaling on a type of the TDD frame structure and a frequency domain resource used for sending the UL signal on another type of the TDD frame structure to achieve subband-level frequency domain isolation”, since all network devices in the same system generally adopt the same DL common signaling transmitting occasion configuration, avoidance of the interference between UEs is accordingly achieved between cells as well.

In addition, an “inter-cell geographic region fencing” scheme may be considered to achieve terminal-side interference avoidance between cells (i.e., each network device, based on geographical position information reported by the terminal, configures a terminal located within an outer ring of the cell to only use the first TDD frame structure, and only schedules a terminal located in an inner ring of the cell to use either the first TDD frame structure or the second TDD frame structure). According to characteristics of the “inter-cell geographic region fencing” scheme, it may be seen that this scheme may achieve avoidance for any potential inter-cell terminal-side interference that is additionally introduced due to usage of a multi-pattern frame structure. Therefore, it may accordingly also avoid the potential co-channel cross-link interference that may exist between “the terminal that is transmitting a UL signal” and “the terminal that is receiving a necessary DL common signaling using another frame structure” between cells.

FIG. 14 is a schematic diagram of a method for interference avoiding based on a TDD multi-pattern frame structure according to the present disclosure. The method is performed by a terminal. As shown in FIG. 14, more specifically, the method includes following steps S1401 to S1402.

At S1401, in a case that the terminal uses a first TDD frame structure, a first UL signal is sent to a network device based on the first TDD frame structure and a first common signaling sent by the network device is received.

At S1402, in a case that the terminal uses a second TDD frame structure, a second UL signal is sent to the network device based on the second TDD frame structure and a second common signaling sent by the network device is received.

The first common signaling and the second UL signal are communicated via different frequency domain resources, and the second common signaling and the first UL signal are communicated via different frequency domain resources.

The second TDD frame structure and the first TDD frame structure have a same frame period and a same UL-DL slot configuration, and the second TDD frame structure has a fixed frame header offset relative to the first TDD frame structure.

In some embodiments, the first common signaling is communicated via a first frequency domain resource, the second UL signal is communicated via a second frequency domain resource, and the first frequency domain resource and the second frequency domain resource are located in different subbands within a frequency band occupied by the network device for communicating a signal; and the second common signaling is communicated via a third frequency domain resource, the first UL signal is communicated via a fourth frequency domain resource, and the third frequency domain resource and the fourth frequency domain resource are located in different subbands within the frequency band occupied by the network device for communicating the signal. In this way, subband-level frequency domain isolation may be achieved between a frequency domain resource used for a common signaling sent on one frame structure and a frequency domain resource used for a UL signal sent on another TDD frame structure.

In some embodiments, in the above description, although names of the first frequency domain resource and the third frequency domain resource are different, the first frequency domain resource and the third frequency domain resource may be the same frequency domain resource or may be different frequency domain resources.

In some embodiments, in the above description, although names of the second frequency domain resource and the fourth frequency domain resource are different, the second frequency domain resource and the fourth frequency domain resource may be the same frequency domain resource or may be different frequency domain resources.

When the first adaptive design scheme in the above network-side embodiments is adopted, for details, reference may be made to the relevant description of the first adaptive design scheme. If the terminal is in an RRC idle state, the terminal performs signal communication before scheduling using the first TDD frame structure. After the terminal completes the signal communication before scheduling, the terminal is configured to perform signal communication after scheduling using the first TDD frame structure or the second TDD frame structure.

The signal communication before scheduling at least includes: the terminal receiving a first common signaling broadcast by the network device before initiating initial random access, the terminal sending a random access preamble signal, and the terminal receiving a random access response sent by the network device.

In some embodiments, after any terminal completes the signal communication before scheduling, the any terminal is configured to perform signal communication after scheduling using the first TDD frame structure or the second TDD frame structure. Whether the terminal is configured to perform the signal communication after scheduling using the first TDD frame structure or the second TDD frame structure after completing the signal communication before scheduling may adopt a scheme such as determination of grouping based on a beam position or other geographical isolation principles, or determination of grouping based on balancing a numerical count of users in two groups.

In some embodiments, after any terminal completes the signal communication before scheduling, the any terminal is configured to perform the signal communication after scheduling using the first TDD frame structure. In the signal communication after scheduling, the terminal uses the first TDD frame structure to receive the first common signaling sent by the network device based on the first TDD frame structure, and, when the UL signal communication is needed, the terminal sends the first UL signal to the network device based on the first TDD frame structure.

In some embodiments, after any terminal completes the signal communication before scheduling, the any terminal is configured to perform the signal communication after scheduling using the second TDD frame structure. In the signal communication after scheduling, the terminal uses the second TDD frame structure to receive the second common signaling sent by the network device based on the second TDD frame structure, and, when the UL signal communication is needed, the terminal sends the second UL signal to the network device based on the second TDD frame structure.

The first common signaling is borne by a signaling beam, and the second common signaling is borne by a service beam.

In some embodiments, if the terminal is configured to use the first TDD frame structure during the signal communication before scheduling or during the signal communication after scheduling, the first common signaling received by the terminal may have following three cases.

1. In a case that a position,
within a cell, of a beam position where the terminal is located is an edge beam position, and a networking mode is a networking mode that provides seamless full-area coverage using TDD, a first common signaling borne by the signaling beam includes a CD-SSB, an SIB1 and OSI, in which the OSI at least includes SIB2, SIB3, SIB4, SIB6, SIB7, SIB8, or SIB19, in which the edge beam position is determined according to a boundary of a coverage area of the network device and a preset distance threshold.

2. In a case that a position,
within a cell, of a beam position where the terminal is located is a non-edge beam position, and a networking mode is a networking mode that provides seamless full-area coverage using TDD, a first common signaling borne by the signaling beam includes a CD-SSB, an SIB1 and OSI, in which the OSI at least includes SIB19, in which the non-edge beam position is determined according to a boundary of a coverage area of the network device and a preset distance threshold.

3. In a case that a networking mode is
a networking mode that performs two-layer networking using FDD and TDD, and the terminal is currently served by a TDD cell, a first common signaling borne by the signaling beam includes a CD-SSB, an SIB1 and OSI, in which the OSI at least includes SIB2, SIB3, SIB4, SIB6, SIB7, SIB8, or SIB19.

In some embodiments, after the terminal completes the signal communication before scheduling, the terminal is configured to perform signal communication after scheduling using the second TDD frame structure. In the signal communication after scheduling, the second common signaling received by the terminal based on the second TDD frame structure only includes an NCD-SSB, in which a period of sending the NCD-SSB is greater than or equal to a period of sending a CD-SSB borne by the signaling beam.

The first common signaling is communicated via a first frequency domain resource, the second UL signal is communicated via a second frequency domain resource, and the first frequency domain resource and the second frequency domain resource are located in different subbands within a frequency band occupied by the network device for communicating a signal. The second common signaling is communicated via a third frequency domain resource, the first UL signal is communicated via a fourth frequency domain resource, and the third frequency domain resource and the fourth frequency domain resource are located in different subbands within the frequency band occupied by the network device for communicating the signal. In this way, subband-level frequency domain isolation may be achieved between a frequency domain resource used for a common signaling sent on one frame structure and a frequency domain resource used for a UL signal sent on another TDD frame structure.

When the second adaptive design scheme in the above network-side embodiments is adopted, for details, reference may be made to the relevant description of the second adaptive design scheme. If the terminal is in an RRC idle state, the terminal performs the signal communication before scheduling using the second TDD frame structure, and after the terminal completes the signal communication before scheduling, the terminal is configured to perform the signal communication after scheduling using the first TDD frame structure or the second TDD frame structure.

The signal communication before scheduling at least includes: the terminal receiving a first common signaling broadcast by the network device before initiating initial random access, the terminal sending a random access preamble signal, and the terminal receiving a random access response sent by the network device.

In some embodiments, after any terminal completes the signal communication before scheduling, the any terminal is configured to perform signal communication after scheduling using the first TDD frame structure or the second TDD frame structure. Whether the terminal is configured to perform the signal communication after scheduling using the first TDD frame structure or the second TDD frame structure after completing the signal communication before scheduling may adopt a scheme such as determination of grouping based on a beam position or other geographical isolation principles, or determination of grouping based on balancing a numerical count of users in two groups.

In some embodiments, after any terminal completes the signal communication before scheduling, the any terminal is configured to perform signal communication after scheduling using the first TDD frame structure. In the signal communication after scheduling, the terminal uses the first TDD frame structure to receive the first common signaling sent by the network device based on the first TDD frame structure, and, when the UL signal communication is needed, the terminal sends the first UL signal to the network device based on the first TDD frame structure.

In some embodiments, after any terminal completes the signal communication before scheduling, the any terminal is configured to perform the signal communication after scheduling using the second TDD frame structure. In the signal communication after scheduling, the terminal uses the second TDD frame structure to receive the second common signaling sent by the network device based on the second TDD frame structure, and, when the UL signal communication is needed, the terminal sends the second UL signal to the network device based on the second TDD frame structure.

The first common signaling is borne by a service beam, and the second common signaling is borne by a signaling beam.

In some embodiments, if the terminal is configured to use the second TDD frame structure during the signal communication before scheduling or during the signal communication after scheduling, a second common signaling received by the terminal may have following three cases.

1. In a case that a position,
within a cell, of a beam position where the terminal is located is an edge beam position, and a networking mode is a networking mode that provides seamless full-area coverage using TDD, a second common signaling borne by the signaling beam includes a CD-SSB, an SIB1 and OSI, in which the OSI at least includes SIB2, SIB3, SIB4, SIB6, SIB7, SIB8, or SIB19, in which the edge beam position is determined according to a boundary of a coverage area of the network device and a preset distance threshold.

2. In a case that a position,
within a cell, of a beam position where the terminal is located is a non-edge beam position, and a networking mode is a networking mode that provides seamless full-area coverage using TDD, a second common signaling borne by the signaling beam includes a CD-SSB, an SIB1 and OSI, in which the OSI at least includes SIB19, in which the non-edge beam position is determined according to a boundary of a coverage area of the network device and a preset distance threshold.

3. In a case that a networking mode is
a networking mode that performs two-layer networking using FDD and TDD, and the terminal is currently served by a TDD cell, a second common signaling borne by the signaling beam includes a CD-SSB, an SIB1 and OSI, in which the OSI at least includes SIB2, SIB3, SIB4, SIB6, SIB7, SIB8, or SIB19.

In some embodiments, after the terminal completes the signal communication before scheduling, the terminal is configured to perform signal communication after scheduling using the first TDD frame structure. In the signal communication after scheduling, the first common signaling received by the terminal based on the first TDD frame structure only includes an NCD-SSB, in which a period of sending the NCD-SSB is greater than or equal to a period of sending a CD-SSB borne by the signaling beam.

The first common signaling is communicated via a first frequency domain resource, the second UL signal is communicated via a second frequency domain resource, and the first frequency domain resource and the second frequency domain resource are located in different subbands within a frequency band occupied by the network device for communicating a signal. The second common signaling is communicated via a third frequency domain resource, the first UL signal is communicated via a fourth frequency domain resource, and the third frequency domain resource and the fourth frequency domain resource are located in different subbands within the frequency band occupied by the network device for communicating the signal. In this way, subband-level frequency domain isolation may be achieved between a frequency domain resource used for a common signaling sent on one frame structure and a frequency domain resource used for a UL signal sent on another TDD frame structure.

When the third adaptive design scheme in the above network-side embodiments is adopted, for details, reference may be made to the relevant description of the third adaptive design scheme. If the terminal is in an RRC idle state, the terminal performs the signal communication before scheduling using the first TDD frame structure or the second TDD frame structure, randomly or based on a position configuration.

In some embodiments, when the terminal is a first part of terminals in the RRC idle state within the cell, the terminal performs signal communication before scheduling using the first TDD frame structure (the signal communication before scheduling at least includes: the terminal receiving a first common signaling broadcast by the network device before initiating initial random access, the terminal sending a random access preamble signal, and the terminal receiving a random access response sent by the network device). After any terminal in the first part of terminals completes the signal communication before scheduling, the any terminal is configured to use the first TDD frame structure or the second TDD frame structure during the subsequent signal communication after scheduling. Or, after any terminal in the first part of terminals completes the signal communication before scheduling, the any terminal is configured to use a TDD frame structure the same as a TDD frame structure used in a case of performing the signal communication before scheduling (i.e., the first TDD frame structure) when performing the signal communication after scheduling.

In some embodiments, when the terminal is a second part of terminals in the RRC idle state within the cell, the terminal performs signal communication before scheduling using the second TDD frame structure (the signal communication before scheduling at least includes: the terminal receiving a second common signaling broadcast by the network device before initiating initial random access, the terminal sending a random access preamble signal, and the terminal receiving a random access response sent by the network device). After any terminal in the second part of terminals completes the signal communication before scheduling, the any terminal is configured to use the first TDD frame structure or the second TDD frame structure during the subsequent signal communication after scheduling. Or, after any terminal in the second part of terminals completes the signal communication before scheduling, the any terminal is configured to use a TDD frame structure the same as a TDD frame structure used in a case of performing the signal communication before scheduling (i.e., the second TDD frame structure) when performing the signal communication after scheduling.

The first part of terminals in the RRC idle state and the second part of terminals in the RRC idle state together constitute all of terminals in the RRC idle state within the cell covered by the network device. A division of the first part and the second part may be performed according to a beam position, or may be balanced according to a numerical count of terminals, or may be performed according to other principles such as a random principle. In some embodiments, if the division of the first part and the second part is performed according to the beam position, after any terminal completes the signal communication before scheduling, in a case that the terminal does not change its beam position due to its own mobility, the terminal is configured to use a TDD frame structure the same as the TDD frame structure used in a case of performing the signal communication before scheduling, when performing the signal communication after scheduling.

In some embodiments, after any terminal completes the signal communication before scheduling, the any terminal is configured to perform signal communication after scheduling using the first TDD frame structure. In the signal communication after scheduling, the terminal uses the first TDD frame structure to receive the first common signaling sent by the network device based on the first TDD frame structure, and, when the UL signal communication is needed, the terminal sends the first UL signal to the network device based on the first TDD frame structure.

In some embodiments, after any terminal completes the signal communication before scheduling, the any terminal is configured to perform the signal communication after scheduling using the second TDD frame structure. In the signal communication after scheduling, the terminal uses the second TDD frame structure to receive the second common signaling sent by the network device based on the second TDD frame structure, and, when the UL signal communication is needed, the terminal sends the second UL signal to the network device based on the second TDD frame structure.

Both the first common signaling and the second common signaling are borne by signaling beams.

In some embodiments, if the terminal is configured to use the second TDD frame structure during the signal communication before scheduling or during the signal communication after scheduling, a second common signaling received by the terminal may have following three cases.
1. In a case that a position, within a cell, of a beam position where the terminal is located is an edge beam position, and a networking mode is a networking mode that provides seamless full-area coverage using TDD, a second common signaling borne by the signaling beam includes a CD-SSB, an SIB1 and OSI, in which the OSI at least includes SIB2, SIB3, SIB4, SIB6, SIB7, SIB8, or SIB19, in which the edge beam position is determined according to a boundary of a coverage area of the network device and a preset distance threshold.
2. In a case that a position, within a cell, of a beam position where the terminal is located is a non-edge beam position, and a networking mode is a networking mode that provides seamless full-area coverage using TDD, a second common signaling borne by the signaling beam includes a CD-SSB, an SIB1 and OSI, in which the OSI at least includes SIB19, in which the non-edge beam position is determined according to a boundary of a coverage area of the network device and a preset distance threshold.
3. In a case that a networking mode is a networking mode that performs two-layer networking using FDD and TDD, and the terminal is currently served by a TDD cell, a second common signaling borne by the signaling beam includes a CD-SSB, an SIB1 and OSI, in which the OSI at least includes SIB2, SIB3, SIB4, SIB6, SIB7, SIB8, or SIB19.

In some embodiments, if the terminal is configured to use the first TDD frame structure during the signal communication before scheduling or during the signal communication after scheduling, a first common signaling received by the terminal may have following three cases.
1. In a case that a position, within a cell, of a beam position where the terminal is located is an edge beam position, and a networking mode is a networking mode that provides seamless full-area coverage using TDD, a first common signaling borne by the signaling beam includes a CD-SSB, an SIB1 and OSI, in which the OSI at least includes SIB2, SIB3, SIB4, SIB6, SIB7, SIB8, or SIB19, in which the edge beam position is determined according to a boundary of a coverage area of the network device and a preset distance threshold.
2. In a case that a position, within a cell, of a beam position where the terminal is located is a non-edge beam position, and a networking mode is a networking mode that provides seamless full-area coverage using TDD, a first common signaling borne by the signaling beam includes a CD-SSB, an SIB1 and OSI, in which the OSI at least includes SIB19, in which the non-edge beam position is determined according to a boundary of a coverage area of the network device and a preset distance threshold.
3. In a case that a networking mode is a networking mode that performs two-layer networking using FDD and TDD, and the terminal is currently served by a TDD cell, a first common signaling borne by the signaling beam includes a CD-SSB, an SIB1 and OSI, in which the OSI at least includes SIB2, SIB3, SIB4, SIB6, SIB7, SIB8, or SIB19.

The first common signaling is communicated via a first frequency domain resource, the second UL signal is communicated via a second frequency domain resource, and the first frequency domain resource and the second frequency domain resource are located in different subbands within a frequency band occupied by the network device for communicating a signal. The second common signaling is communicated via a third frequency domain resource, the first UL signal is communicated via a fourth frequency domain resource, and the third frequency domain resource and the fourth frequency domain resource are located in different subbands within the frequency band occupied by the network device for communicating the signal. In this way, subband-level frequency domain isolation may be achieved between a frequency domain resource used for a common signaling sent on one frame structure and a frequency domain resource used for a UL signal sent on another TDD frame structure.

FIG. 15 is a schematic diagram of an apparatus for interference avoiding based on a TDD multi-pattern frame structure according to the present disclosure. As shown in FIG. 15, the apparatus 1500 for interference avoiding based on a TDD multi-pattern frame structure includes a sending module 1501 and a receiving module 1502.

The sending module 1501 is configured to send a first common signaling based on a first TDD frame structure and send a second common signaling based on a second TDD frame structure.

The receiving module 1502 is configured to receive a first UL signal sent by a terminal using the first TDD frame structure and receive a second UL signal sent by a terminal using the second TDD frame structure.

The first common signaling and the second UL signal are communicated via different frequency domain resources, and the second common signaling and the first UL signal are communicated via different frequency domain resources.

The second TDD frame structure and the first TDD frame structure have a same frame period and a same UL-DL slot configuration, and the second TDD frame structure has a fixed frame header offset relative to the first TDD frame structure.

In this apparatus, the first common signaling and the second UL signal are communicated via different frequency domain resources, and the second common signaling and the first UL signal are communicated via different frequency domain resources. In this way, frequency domain isolation may be achieved between a frequency domain resource used for a common signaling transmitted by a frame structure and a frequency domain resource used for a UL signal transmitted by another TDD frame structure, thus avoiding potential co-channel cross-link interference that may exist between “a terminal that is transmitting a UL signal” and “a terminal that is receiving a necessary DL common signaling” within a cell.

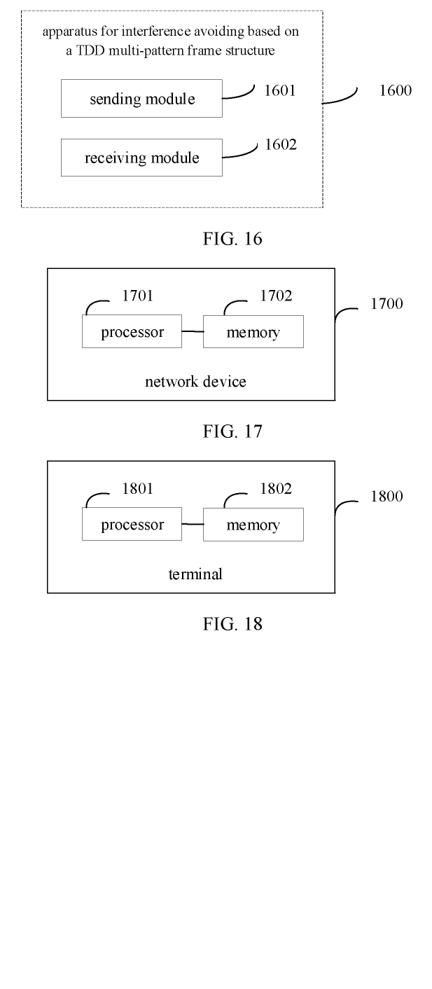

FIG. 16 is a schematic diagram of an apparatus for interference avoiding based on a TDD multi-pattern frame structure according to the present disclosure. As shown in FIG. 16, the apparatus 1600 for interference avoiding based on a TDD multi-pattern frame structure includes a sending module 1601 and a receiving module 1602.

The sending module 1601 is configured to: in a case that the terminal uses a first TDD frame structure, send a first UL signal to a network device based on the first TDD frame structure; or, in a case that the terminal uses a second TDD frame structure, send a second UL signal to the network device based on the second TDD frame structure.

The receiving module 1602 is configured to: in a case that the terminal uses the first TDD frame structure, receive a first common signaling sent by the network device based on the first TDD frame structure; or, in a case that the terminal uses the second TDD frame structure, receive a second common signaling sent by the network device based on the second TDD frame structure.

The first common signaling and the second UL signal are communicated via different frequency domain resources, and the second common signaling and the first UL signal are communicated via different frequency domain resources.

The second TDD frame structure and the first TDD frame structure have a same frame period and a same UL-DL slot configuration, and the second TDD frame structure has a fixed frame header offset relative to the first TDD frame structure.

In this apparatus, the first common signaling and the second UL signal are communicated via different frequency domain resources, and the second common signaling and the first UL signal are communicated via different frequency domain resources. In this way, frequency domain isolation may be achieved between a frequency domain resource used for a common signaling transmitted by a frame structure and a frequency domain resource used for a UL signal transmitted by another TDD frame structure, thus avoiding potential co-channel cross-link interference that may exist between “a terminal that is transmitting a UL signal” and “a terminal that is receiving a necessary DL common signaling” within a cell.

To achieve the above embodiments, embodiments of the present disclosure further provide a network device 1700. As shown in FIG. 17, the network device 1700 includes: at least one processor 1701 and a memory 1702 communicatively coupled to the at least one processor. The memory 1702 stores instructions executable by the at least one processor that, when executed by the at least one processor 1701, cause the method for interference avoiding based on a TDD multi-pattern frame structure on a network device side as shown in the above embodiments to be implemented.

To achieve the above embodiments, embodiments of the present disclosure further provide a terminal 1800. As shown in FIG. 18, the terminal 1800 includes: a processor 1801 and a memory 1802 communicatively coupled to the processor. The memory 1802 stores instructions executable by at least one processor that, when executed by the at least one processor 1801, cause the method for interference avoiding based on a TDD multi-pattern frame structure on a terminal side as shown in the above embodiments to be implemented.

To achieve the above embodiments, embodiments of the present disclosure further provide a non-transitory computer-readable storage medium for storing computer instructions. The computer instructions are configured to cause a computer to implement the method for interference avoiding based on a TDD multi-pattern frame structure on a network device side or to implement the method for interference avoiding based on a TDD multi-pattern frame structure on a terminal side.

In the description of the present disclosure, it needs to be understood that, terms such as “center”, “longitudinal”, “lateral”, “length”, “width”, “thickness”, “over”, “below”, “front”, “back”, “left”, “right”, “vertical”, “horizontal”, “top”, “bottom”, “in”, “out”, “clockwise”, “anti-clockwise”, “axial”, “radial” and “circumference” refer to the directions and position relations which are the directions and position relations shown in the drawings, and for describing the present disclosure and for describing in simple, and which are not intended to indicate or imply that the device or the elements are disposed to locate at the specific directions or are structured and performed in the specific directions, which may not be understood as the limitation of the present disclosure.

In addition, terms such as “first” and “second” are used herein for purposes of description and are not intended to indicate or imply relative importance or imply a numerical count of technical features being indicated. Furthermore, the feature defined with “first” and “second” may include one or more features distinctly or implicitly. In the description of the present disclosure, “a plurality of” means two or more than two, unless specified otherwise.

Reference throughout this specification to “an embodiment”, “some embodiments”, “an example”, “a specific example”, or “some examples” means that a particular feature, structure, material, or characteristic described in connection with an embodiment or an example is included in at least one embodiment or example of the present disclosure. The appearances of the above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction.

Although embodiments of the present disclosure have been shown and described above, it may be understood that, the above embodiments are illustrative, and may not be construed to limit the present disclosure. The skilled in the art may make changes, modifications, substitutions and variations in the above embodiments within the scope of the present disclosure.

1. A method for interference avoiding based on a time division duplex (TDD) multi-pattern frame structure, performed by a network device, comprising:
sending a first common signaling based on a first TDD frame structure and sending a second common signaling based on a second TDD frame structure; and
receiving a first uplink (UL) signal sent by a terminal using the first TDD frame structure and receiving a second UL signal sent by the terminal using the second TDD frame structure,
wherein the first common signaling and the second UL signal are communicated via different frequency domain resources, and the second common signaling and the first UL signal are communicated via different frequency domain resources; and
wherein the second TDD frame structure and the first TDD frame structure have a same frame period and a same UL-downlink (DL) slot configuration, and the second TDD frame structure has a fixed frame header offset relative to the first TDD frame structure.

2. The method of claim 1, wherein
the first common signaling is communicated via a first frequency domain resource, the second UL signal is communicated via a second frequency domain resource, and the first frequency domain resource and the second frequency domain resource are located in different subbands within a frequency band occupied by the network device for communicating a signal; and
the second common signaling is communicated via a third frequency domain resource, the first UL signal is communicated via a fourth frequency domain resource, and the third frequency domain resource and the fourth frequency domain resource are located in different subbands within the frequency band occupied by the network device for communicating the signal.

3. The method of claim 2, wherein
the first frequency domain resource and the third frequency domain resource are a same frequency domain resource or are different frequency domain resources; and
the second frequency domain resource and the fourth frequency domain resource are a same frequency domain resource or are different frequency domain resources.

4. The method of claim 2, wherein the network device performs a slot configuration using at least one of following schemes:
all of DL slots on the first TDD frame structure being configured to use the first frequency domain resource and all of UL slots on the second TDD frame structure being configured to use the second frequency domain resource; or
all of DL slots on the second TDD frame structure being configured to use the third frequency domain resource and all of UL slots on the first TDD frame structure being configured to use the fourth frequency domain resource.

5. The method of claim 1, wherein
both the first common signaling and the second common signaling are borne by signaling beams.

6. The method of claim 5, wherein, for any beam position, a number of times a common signaling borne by the signaling beam appears in the DL slot of its corresponding TDD frame structure is determined by a revisit period of the signaling beam to the any beam position, wherein the signaling beam is used for broadcasting a synchronization signal and a system message and for initial access of the terminal, and the signaling beam provides a service to different beam positions using a time-division polling mechanism.

7. The method of claim 6, wherein a signal comprised in the common signaling borne by the signaling beam is determined based on:
determining the signal comprised in the common signaling according to a networking mode of the network device and a position, within a cell, of a beam position currently served by the signaling beam that bears the common signaling;
wherein the networking mode is that the network device adopts a networking mode that provides seamless full-area coverage using TDD, or is that the network device adopts a networking mode that performs two-layer networking using frequency division duplex (FDD) and TDD; and
wherein the position of the beam position within the cell is an edge beam position or a non-edge beam position, and the edge beam position and the non-edge beam position are determined according to a boundary of a coverage area of the network device and a preset distance threshold.

8. The method of claim 7, wherein determining the signal comprised in the common signaling according to the networking mode of the network device and the position, within the cell, of the beam position currently served by the signaling beam that bears the common signaling comprises at least one of:
in a case that the network device adopts the networking mode that provides the seamless full-area coverage using the TDD, and the position, within the cell, of the beam position currently served by the signaling beam that bears the common signaling is the edge beam position, the common signaling comprising a cell-defining synchronization signal block (CD-SSB), a system information block 1 (SIB1) and other system information (OSI), wherein the OSI at least comprises SIB2, SIB3, SIB4, SIB6, SIB7, SIB8, or SIB19;
in a case that the network device adopts the networking mode that provides the seamless full-area coverage using the TDD, and the position, within the cell, of the beam position currently served by the signaling beam that bears the common signaling is the non-edge beam position, the common signaling comprising a CD-SSB, an SIB1 and OSI, wherein the OSI at least comprises SIB19; or
in a case that the network device adopts the networking mode that performs two-layer networking using the FDD and the TDD, and the signaling beam that bears the common signaling currently serves any beam position of a TDD cell, the common signaling comprising a CD-SSB, an SIB1 and OSI, wherein the OSI at least comprises SIB2, SIB3, SIB4, SIB6, SIB7, SIB8, or SIB19.

9. The method of claim 5, wherein the network device configures a part of a plurality of terminals, within a cell covered by the network device, that are in an RRC idle state to perform signal communication before scheduling using the first TDD frame structure, and configures another part of the plurality of terminals to perform the signal communication before scheduling using the second TDD frame structure; and
configures any terminal of the plurality of terminals to perform signal communication after scheduling using the first TDD frame structure or the second TDD frame structure, or configures any terminal of the plurality of terminals to perform signal communication after scheduling using a TDD frame structure the same as a TDD frame structure used in a case of performing the signal communication before scheduling.

10. The method of claim 9, wherein the signal communication before scheduling at least comprises: the terminal receiving a common signaling broadcast by the network device before initiating initial random access, the terminal sending a random access preamble signal, and the terminal receiving a random access response sent by the network device.

11. The method of claim 5, wherein the first UL signal is a random access preamble signal, and a UL slot occupied in the first TDD frame structure is a time domain resource corresponding to a random access channel occasion configured by the network device for a terminal using the first TDD frame structure; or
wherein the second UL signal is a random access preamble signal, and a UL slot occupied in the second TDD frame structure is a time domain resource corresponding to a random access channel occasion configured by the network device for a terminal using the second TDD frame structure.

12. The method of claim 5, wherein
in a case that the second UL signal is a UL signal other than a random access preamble signal, and DL slots corresponding to the first common signaling within the first TDD frame structure belong to a same frame period, the second UL signal occupies at least one UL slot within a UL slot group of the second TDD frame structure, the DL slots corresponding to the first common signaling within the first TDD frame structure belong to one DL slot group, and the UL slot group is immediately after the DL slot group;
in a case that the first UL signal is a UL signal other than a random access preamble signal, and DL slots corresponding to the second common signaling within the second TDD frame structure belong to a same frame period, the first UL signal occupies at least one UL slot within a UL slot group of the first TDD frame structure, the DL slots corresponding to the second common signaling within the second TDD frame structure belong to one DL slot group, and the UL slot group is immediately after the DL slot group;
in a case that the second UL signal is a UL signal other than a random access preamble signal, and a plurality of parts of the first common signaling respectively occupy at least one DL slot within a plurality of DL slot groups that belongs to different frame periods within the first TDD frame structure, the second UL signal respectively occupies at least one UL slot within a plurality of UL slot groups of the second TDD frame structure, and the plurality of UL slot groups are immediately after the plurality of DL slot groups, respectively; or
in a case that the first UL signal is a UL signal other than a random access preamble signal, and a plurality of parts of the second common signaling respectively occupy at least one DL slot within a plurality of DL slot groups that belongs to different frame periods within the second TDD frame structure, the first UL signal respectively occupies at least one UL slot within a plurality of UL slot groups of the first TDD frame structure, and the plurality of UL slot groups are immediately after the plurality of DL slot groups, respectively.

13. The method of claim 1, wherein the frame header offset is configured as a sum of a numerical count of UL slots and a numerical count of DL slots in the first TDD frame structure, or the frame header offset is configured as a numerical count of guard period (GP) slots in the first TDD frame structure.

14. A method for interference avoiding based on a time division duplex (TDD) multi-pattern frame structure, performed by a terminal, comprising:
in a case that the terminal uses a first TDD frame structure, sending a first uplink (UL) signal to a network device based on the first TDD frame structure and receiving a first common signaling sent by the network device; and
in a case that the terminal uses a second TDD frame structure, sending a second UL signal to the network device based on the second TDD frame structure and receiving a second common signaling sent by the network device,
wherein the first common signaling and the second UL signal are communicated via different frequency domain resources, and the second common signaling and the first UL signal are communicated via different frequency domain resources; and
wherein the second TDD frame structure and the first TDD frame structure have a same frame period and a same UL-downlink (DL) slot configuration, and the second TDD frame structure has a fixed frame header offset relative to the first TDD frame structure.

15. The method of claim 14, wherein
the first common signaling is communicated via a first frequency domain resource, the second UL signal is communicated via a second frequency domain resource, and the first frequency domain resource and the second frequency domain resource are located in different subbands within a frequency band occupied by the network device for communicating a signal; and
the second common signaling is communicated via a third frequency domain resource, the first UL signal is communicated via a fourth frequency domain resource, and the third frequency domain resource and the fourth frequency domain resource are located in different subbands within the frequency band occupied by the network device for communicating the signal.

16. The method of claim 15, wherein
the first frequency domain resource and the third frequency domain resource are a same frequency domain resource or are different frequency domain resources; and
the second frequency domain resource and the fourth frequency domain resource are a same frequency domain resource or are different frequency domain resources.

17. The method of claim 14, wherein
both the first common signaling and the second common signaling are borne by signaling beams.

18. The method of claim 17, further comprising at least one of:
in a case that a position, within a cell, of a beam position where the terminal is located is an edge beam position, and a networking mode is a networking mode that provides seamless full-area coverage using TDD, a common signaling borne by the signaling beam comprising a cell-defining synchronization signal block (CD-SSB), a system information block 1 (SIB1) and other system information (OSI), wherein the OSI at least comprises SIB2, SIB3, SIB4, SIB6, SIB7, SIB8, or SIB19, wherein the edge beam position is determined according to a boundary of a coverage area of the network device and a preset distance threshold;
in a case that a position, within a cell, of a beam position where the terminal is located is a non-edge beam position, and a networking mode is a networking mode that provides seamless full-area coverage using TDD, a common signaling borne by the signaling beam comprising a CD-SSB, an SIB1 and OSI, wherein the OSI at least comprises SIB19, wherein the non-edge beam position is determined according to a boundary of a coverage area of the network device and a preset distance threshold; or
in a case that a networking mode is a networking mode that performs two-layer networking using frequency division duplex (FDD) and TDD, and the terminal is currently served by a TDD cell, a common signaling borne by the signaling beam comprising a CD-SSB, an SIB1 and OSI, wherein the OSI at least comprises SIB2, SIB3, SIB4, SIB6, SIB7, SIB8, or SIB19.

19. The method of claim 17, further comprising:
in a case that the terminal is in an RRC idle state, performing signal communication before scheduling using the first TDD frame structure or the second TDD frame structure, and performing signal communication after scheduling using the first TDD frame structure or the second TDD frame structure, or performing signal communication after scheduling using a TDD frame structure the same as a TDD frame structure used in a case of performing the signal communication before scheduling .

20. The method of claim 19, wherein the signal communication before scheduling at least comprises: receiving a common signaling broadcast by the network device before initiating initial random access, sending a random access preamble signal, and receiving a random access response sent by the network device.

21. A network device, comprising:
at least one processor; and
a memory communicatively coupled to the at least one processor;
wherein the at least one processor is configured to:
send a first common signaling based on a first TDD frame structure and send a second common signaling based on a second TDD frame structure; and
receive a first uplink (UL) signal sent by a terminal using the first TDD frame structure and receive a second UL signal sent by the terminal using the second TDD frame structure,
wherein the first common signaling and the second UL signal are communicated via different frequency domain resources, and the second common signaling and the first UL signal are communicated via different frequency domain resources; and
wherein the second TDD frame structure and the first TDD frame structure have a same frame period and a same UL-downlink (DL) slot configuration, and the second TDD frame structure has a fixed frame header offset relative to the first TDD frame structure.

22. A terminal, comprising:
at least one processor; and
a memory communicatively coupled to the at least one processor, wherein
the at least one processor is configured to implement the method of claim 14.
